(19) United States
(12) Patent Application Publication
(10) Pub. No.: US 2003/0192008 A1
(43) Pub. Date: Oct. 9, 2003

(54) System and method for comprising manual function for managing a form

(76) Inventor: Hong_Kyu Lee, Incheon (KR)

Correspondence Address: PERKINS COIE LLP, PATENT-SEA, P.O. BOX 1247, SEATTLE, WA, 98111-1247, US

(21) Appl. No.: 10/258,903

(22) PCT Filed: Sep. 15, 2001
(86) PCT No.: PCT/KR01/01549

(30) Foreign Application Priority Data
Sep. 16, 2000 (KR) 2000/54423

(51) Int. Cl. G06F 15/00

(52) U.S. Cl. 715/506

(57) ABSTRACT

The present invention relates to system and method for comprising manual function for filling in a form. More particularly, the present invention relates to an electronic file is composed of a form and at least one manual fo filling in the form, which file can be made by one user and provided to the other users. According to user's ‘open’ command, a user terminal displays a requested form comprising manual function on the screen. Afterwards, if a cursor is located in a pre-designated range (such as blank in a sentence, cell in a table, etc.) for automatically executing a manual function, the user terminal automatically searches for a manual corresponding to the pre-designated range. And the user terminal displays the searched manual on the pre-designated area of the screen. Thereby the form can be filled out easily without any other information or other people's assistance.

### TECHNICAL FIELD

The present invention relates to system and method for comprising manual function for filling in a form. More particularly, the present invention relates to system and method for comprising manual function for easily inputting pertinent information to an arbitrary blank by the standard way.

### BACKGROUND ART

A document was prepared by using a writing material in former day. But, as the techniques are progressed, a word processor installed in a user terminal (e.g., personal computer and the like) can make out a document.

Presently, many a form, which is made out by using a word processor, is used for many a use (e.g., lending material, making a bankbook, etc., in a public institution, a bank and the like).

A word processor is an equipment or a program compromising functions for editing, saving the document, printing, sending or receiving the document of various format at need.

There are several merits that can be expected from using a word processor. First, a user can save the endeavor and time for making out a document. Second, a user can reproduce the same contents over and over again, needless to make out a document again. Third, a user can manage a completed document easily in case of custody, retrieval and so forth. Fourth, in recent years, owing to the advancement of the technology of communications, a user can send the completed document to any other user, and share the completed document with any other user.

As mentioned above, a word processor, which gives convenience to a user, provides several functions such as inputting a text or a figure, displaying a completed document on a screen of the personal computer, editing the displayed document under user's intent, saving the completed document or sharing with a plurality of users.

Presently, the word processor is a kind of application program that is installed and used in personal computer. Namely, after a user installs various programs (such as a word processor, an image viewer, an web browser and the like) in the personal computer, the user uses selectively an arbitrary program among the installed programs.

When a user makes out a form by using the word processor, the user fills pertinent information in blank items (e-g., a name, a national registration number, a credit card number and the like) of a pre-designated form by referring to a pre-formatted example document.

And, a word processor (such as HANGEUL, Microsoft Word and so on.) may include preparation samples in the pre-formatted example documents (e.g., a form which includes a corresponding preparation sample). Hereinafter, both a group of pre-formatted example documents and each of pre-formatted example documents are defined as MUSEO MADANG.

The MUSEO MADANG of HANGEUL is similar to Template Gallery of Microsoft Office. That is, with MUNSEO MADANG designed just for object of job search, resumes, cover letters, letters of acceptance, and the like, the user can avoid the overwhelming task of starting with a blank page. Therefore, the user may find easily the desired pre-formatted example documents in MUNSEOMADANG.

Hereinafter, the method for filling in a form by using a MUNSEO MADANG (which is provided by the conventional word processor) will be described. But, the conventional Korean word processor takes HANGEUL an example.

FIGS. 1 and 2 are document formats for illustrating the MUNSEO MADANG provided by the conventional word processor. That is, FIGS. 1 and 2 show the occasional document forms that a person fills in the blank when he would like to have vacation with reference in the MUNSEO MADANG.

With reference to FIG. 1, a vacation request is displayed on the screen of a user's computer. The vacation request includes a plurality of items for being made out to be inputted pertinent information (such as an ‘APPLICANT’, a ‘RANK’, a ‘DATE’, a ‘REASON’ and so on.). The each item includes corresponding short explanation what to be inputted in the item (In FIG. 1, for convenience' sake, only the ‘APPLICANT’ includes the short explanation.).

The item of ‘APPLICANT’ (when a user would like to have vacation, the user has to input his name in the item) can include the short explanation. For example, the short explanation is ‘APPLICANT: Click this area with your mouse and input your name’.

The virtual preparation form of the ‘Click this area with the your mouse and input your name’ area is ‘{NURMTLE { } Click this area with the your mouse and input your name. { } NURMTLE}’. (Hereinafter, NURMTLE is defined the composition mark for creating a form including the short explanation.) But, before the user selects composition mark on the View menu, the short explanation is displayed in the screen. Therefore, the virtual preparation form is not displayed if the user selects composition mark on the View menu.

When the user clicks the ‘Click this area with the your mouse and input your name’ area for inputting his name, the occasional document such as FIG. 2 is displayed on the screen.

With reference to FIG. 2, the short explanation of FIG. 1 is disappeared and the inputting-area (┌ ┘) for inputting the user's name is displayed.

But, the conventional form-generating system, such as a word processor, has a limit that it has to place more importance on the function for making and printing a document.

Also, because the conventional form-generating system runs only by user's command for executing an arbitrary function, a user has disadvantage which the user has to read a manual if necessary for understanding an arbitrary function, a usage and so on.

Also, according to the MUNSEO MADANG (which is provided in the conventional word processor), when the user selects in the pre-determined area with an input device (such as a mouse), the preparation sample relevant to the selected area is disappeared and the area for the preparation sample converts into the area for inputting the pertinent information. Thus, the MUNSEO MADANG according to the conventional word processor is not suitable for a form requested inputting complicated information.

### DISCLOSURE OF THE INVENTION

In view of the foregoing and other disadvantage of the conventional system and method, an object of the present invention is to provide a system and method for comprising manual function for filling in a form, which the system and method can display a relevant manual automatically on the screen, when a user is filling in a form that is set to be included a relevant manual in advance, in case that a form-generating man make a form along with a manual including a kind and a trait of information being inputted in the form.

It is another object of the present invention to provide a system and method for comprising manual function for filling in a form, which the system and method can always be used for filling in a form regardless of a network interruption.

It is another object of the present invention to provide a system and method for comprising manual function for filling in a form, which the system and method can utilize the stored data in an internal storing section as well as an external database for the manual function by user's request, if the system is connected with the external database through network.

To achieve the above object, there is provided a method for generating a form comprising manual function by using a form management program, wherein the form management program is installed in a user terminal and executed according to an execution command of a user. The method may comprise the step of displaying a working document on a screen of the user terminal, the step of displaying a manual-inserting area corresponding to the manual-inserting command on the screen, when a manual-inserting command is inputted from the user, the step of linking a position information to a manual information, when the manual information is inputted in the manual-inserting area, wherein the position information is equivalent to the cursor position in case that the manual-inserting command is inputted in a working document, and the step of saving the manual information in a storage device.

The method for generating the form may further comprise the step of inserting at least one subsidiary form in the manual-inserting area wherein the subsidiary form comprises at least one selected from the group consisting of a table, a text and a figure.

The method for generating the form may further comprise the step of displaying the manual-inserting area corresponding to the manual-inserting command on the screen, when the manual-inserting command is inputted at a position in the subsidiary form by user, the step of linking a position information to a manual information, when the manual information is inputted in the manual-inserting area, wherein the position information is equivalent to the cursor position in case that the manual-inserting command is inputted in the working document, and the step of saving the manual information in the storage device.

The form management program comprises a manual-addition function in the form and the user terminal is at least one selected from the group consisting of a computer, a mobile phone, a personal digital assistant (PDA) and the like. The form management program is at least one selected from the group consisting of a word processor, a spreadsheet, a web site creation and management tool, a mapping program, a diagramming program, an image editing program and the like.

The position information corresponding to the manual-inserting command is a range information comprising a cursor position of at least one selected from the group consisting of a table, a text and a figure in the working document.

Moreover, there is provided a method for using a form comprising manual function by using a form management program, wherein the form management program is installed in a user terminal and executed according to a execution command of a user. The method may comprise the step of displaying the form comprising manual function on a screen of the user terminal, when an ‘open’ command for displaying the form comprising manual function is inputted by user, the step of determining whether a cursor is located in a pre-designated range or not, wherein the pre-designated range is designated for automatically executing a manual function, the step of retrieving a manual corresponding to the pre-designated range, when the cursor is located in the pre-designated range, and the step of displaying the manual on the screen.

The step of displaying the manual on the screen comprises at least one selected from the group consisting of a step of splitting the display into two, a step of using a dialog box and a method of using a alarm message so as to display the manual and the form on the screen.

The method for using the form may further comprise the step of displaying a manual corresponding to the subsidiary form, when the manual comprises at least one subsidiary form, wherein the subsidiary form can be selectively inserted in the form by user, the step of retrieving the subsidiary form in a storage device, when the selection information of a subsidiary form is inputted by user, and the step of inserting the subsidiary form in the form.

The method for using the form may further comprise the step of retrieving a manual corresponding to the pre-designated range, when the subsidiary form comprises a manual and the cursor is located in the pre-designated range for automatically executing a manual function, and the step of displaying the manual on the screen.

Moreover, there is provided a method for generating a form comprising manual function by using a network. The method may comprise the step of receiving a document-generating request from a user terminal, the step of receiving a manual-inserting request at a position in a working document from the user terminal, the step of sending a manual-inserting area corresponding to the manual-inserting request to the user terminal, the step of receiving a manual information from the user terminal, wherein the manual information is inputted in the manual-inserting area, the step of linking a position information to the manual information, when the manual information is inputted in the manual-inserting area, wherein the position information is equivalent to a cursor position in case that the manual-inserting request is inputted in a working document, and the step of saving the manual information in a storage device.

The method for generating the form may further comprise the step of inserting at least one subsidiary form in the manual-inserting area, wherein the subsidiary form comprises at least one of a table, a text and a figure.

The method for generating the form may further comprise the step of receiving the manual-inserting request at a position in the subsidiary form from user terminal, the step of sending a manual-inserting area corresponding to the manual-inserting request to user terminal, the step of receiving a manual information which is inputted in the manual-inserting area, the step of linking a position information to the manual information, when the manual information is inputted in the manual-inserting area, wherein the position information is equivalent to the cursor position in case that the manual-inserting request is inputted in the working document, and the step of saving the manual information in the storage device.

The network can be allowed a wireless communication or a cable communication and the user terminal can be at least one selected from the group consisting of a computer, a mobile phone and a personal digital assistant (PDA).

Moreover, there is provided a method for using a form comprising manual function by using a network. The method may comprise the step of receiving an ‘open’ request for displaying a form from a user terminal, the step of retrieving a form corresponding to the ‘open’ request in a storage device, the step of sending the form to the user terminal, the step of retrieving a manual corresponding to the pre-designated range, when the form comprises manual function and a cursor is located in the pre-designated range for automatically executing a manual function, and the step of sending the manual to the user terminal.

The method for using the form may further comprise the step of sending a manual corresponding to a subsidiary form, when the manual comprises at least one subsidiary form, wherein the subsidiary form can be selectively inserted in the form by user, the step of retrieving the subsidiary form in a storage device, when the selection information of a subsidiary form is received from the user terminal, and the step of inserting the subsidiary form in the form.

The method for using the form may further comprise the step of retrieving a manual corresponding to the pre-designated range in the storage device, when the subsidiary form comprises corresponding manual and the cursor is located in the pre-designated range for automatically executing a manual function, and the step of sending the retrieved manual to user terminal.

Moreover, there is provided a system for generating a form comprising manual function by using a network. The system may comprise the means for receiving a document-generating request, a manual-inserting request or a manual information from a user terminal, the means for sending a manual-inserting area corresponding to the manual-inserting request to user terminal, the means for linking a position information to the manual information, when the manual information is inputted in the manual-inserting area, wherein the position information is equivalent to a cursor position in case that the manual-inserting request is inputted in a working document, and the means for saving the manual information.

Moreover, there is provided a system for providing a form comprising manual function by using a network. The system may comprise the means for receiving an ‘open’ request for displaying a form from a user terminal, the means for retriving a form or manual corresponding to the user's ‘open’ request, the means for sensing a cursor position, and the means for sending the form or manual to the user terminal.

Moreover, there is provided an apparatus for generating a form comprising manual function. The apparatus may comprise a storage device, and a processor coupled to the storage device. Wherein the storage device storing a program for controlling the processor, and the processor operative with the program to receive a document-generating request from a user terminal, to receive a manual-inserting request at a position in a working document from the user terminal, to send a manual-inserting area corresponding to the manual-inserting request to the user terminal, to receive a manual information from the user terminal, wherein the manual information is inputted in the manual-inserting area, to set a position information to be linked the manual information, when the manual information is inputted in the manual-inserting area, wherein the position information is equivalent to the cursor position in case that the manual-inserting command is inputted in the working document, and to save the manual information in a storage device.

The processor may further operate with the program to comprise at least one subsidiary form in the manual-inserting area wherein the subsidiary form comprises at least one selected from the group consisting of a table, a text and a figure.

The processor may further operate with the program to receive the manual-inserting request at a position in the subsidiary form from user terminal, to send a manual-inserting area corresponding to the manual-inserting request to user terminal, to receive a manual information from the user terminal, wherein the manual information is inputted in the manual-inserting area, to set a position information to be linked the manual information, when the manual information is inputted in the manual-inserting area, wherein the position information is equivalent to the cursor position in case that the manual-inserting command is inputted in the working document, and to save the manual information in the storage device.

Moreover, there is provided an apparatus for using a form comprising manual function. The apparatus may comprise a storage device and a processor coupled to the storage device. Wherein the storage device storing a program for controlling the processor, and the processor operative with the program to receive an ‘open’ request for displaying a form from a user terminal, to retrieve a form corresponding to the ‘open’ request in a storage device, to send the form to the user terminal, to retrieve a manual corresponding to the pre-designated range, when the form comprises manual function and a cursor is located in the pre-designated range for automatically executing a manual function, and to send the manual to the user terminal.

The processor may further operate with the program to send a manual corresponding to a subsidiary form, when the manual comprises at least one subsidiary form, wherein the subsidiary form can be selectively inserted in the form by user, to retrieve the subsidiary form in a storage device, when the selection information of a subsidiary form is received from the user terminal, and to insert the subsidiary form in the form.

The processor may further operate with the program to retrieve a manual corresponding to the pre-designated range in the storage device, when the subsidiary form comprises corresponding manual and the cursor is located in the pre-designated range for automatically executing a manual function, and to sending the retrieved manual to user terminal.

Moreover, there is provided a computer-readable medium having stored thereon computer-executable instructions and realized in concrete by program of instructions, which could be executable by digital processing unit, for generating a form comprising manual function, the method for generating the form comprising the step of displaying a working document on a screen of a user terminal, the step of displaying a manual-inserting area corresponding to the manual-inserting command on the screen, when a manual-inserting command is inputted from the user, the step of linking a position information to a manual information, when the manual information is inputted in the manual-inserting area, wherein the position information is equivalent to the cursor position in case that the manual-inserting command is inputted in a working document, the step of saving the manual information in a storage device.

The instructions may further perform the step of inserting at least one subsidiary form in the manual-inserting area wherein the subsidiary form comprises at least one selected from the group consisting of a table, a text and a figure.

The instructions may further perform the step of displaying the manual-inserting area corresponding to the manual-inserting command on the screen, when the manual-inserting command is inputted at a position in the subsidiary form by user, the step of linking a position information to a manual information, when the manual information is inputted in the manual-inserting area, wherein the position information is equivalent to the cursor position in case that the manual-inserting command is inputted in the working document, and the step of saving the manual information in the storage device.

Moreover, there is provided a computer-readable medium having stored thereon computer-executable instructions and realized in concrete by program of instructions, which could be executable by digital processing unit, for using a form comprising manual function, the method for using the form comprising the step of displaying the form comprising manual function on a screen of a user terminal, when an ‘open’ command for displaying the form comprising manual function is inputted by user, the step of determining whether a cursor is located in a pre-designated range or not, wherein the pre-designated range is designated for automatically executing a manual function, the step of retrieving a manual corresponding to the pre-designated range, when the cursor is located in the pre-designated range, and the step of displaying the manual on the screen.

The instructions further perform the step of displaying a manual corresponding to a subsidiary form, when the manual comprises at least one subsidiary form, wherein the subsidiary form can be selectively inserted in the form by user, the step of retrieving the subsidiary form in a storage device, when the selection information of a subsidiary form is inputted by user, and the step of inserting the subsidiary form in the form.

The instructions further perform the step of retrieving a manual corresponding to the pre-designated range, when the subsidiary form comprises a manual and the cursor is located in the pre-designated range for automatically executing a manual function, and the step of displaying the manual on the screen.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings embodiments that are presently preferred, it being understood, however, that the invention is not limited to the specific methods and instrumentalities disclosed. In the drawings:

FIGS. 1 and 2 are document formats for illustrating the MUNSEO MADANG provided by the conventional word processor;

FIG. 3 is a partial front isometric, partial block diagram of a form-generating system by using network in accordance with one preferred embodiment of the present invention;

FIG. 4 is a flow chart illustrating form-generating process for creating a form including manual information in accordance with one preferred embodiment of the present invention;

FIGS. 5, 6 and 7 illustrate a form-generating window for creating a form including manual information in accordance with one preferred embodiment of the present invention;

FIG. 8 is a flow chart for explaining a form-selecting process for utilizing a form including manual information in accordance with another preferred embodiment of the present invention;

FIGS. 9, 10 and 11 illustrate a form-application window for utilizing a form including manual information in accordance with another preferred embodiment of the present invention;

FIG. 12 is a block diagram of a form management system in the shape of a stand-alone type in accordance with still another preferred embodiment of the present invention;

FIGS. 13, 14, 15, 16 and 17 illustrate a form-application window for utilizing a form including manual information in accordance with still another preferred embodiment of the present invention;

FIG. 18 illustrates a form-generating window for creating a form including manual information in accordance with still another preferred embodiment of the present invention;

FIGS. 19, 20, 21 and 22 illustrate a form-generating window for creating a form including separated at least one manual information in accordance with still another preferred embodiment of the present invention;

FIGS. 23, 24, 25 and 26 illustrate an auto fill-in window for inserting pertinent information automatically by user's selection in the predetermined choices in accordance with still another preferred embodiment of the present invention;

FIGS. 27, 28 and 29 illustrate various form-application windows in accordance with still another preferred embodiments of the present invention;

FIGS. 30, 31 and 32 illustrate a form-creating window by user's selecting a manual in the predetermined at least one manuals in accordance with still another preferred embodiments of the present invention.

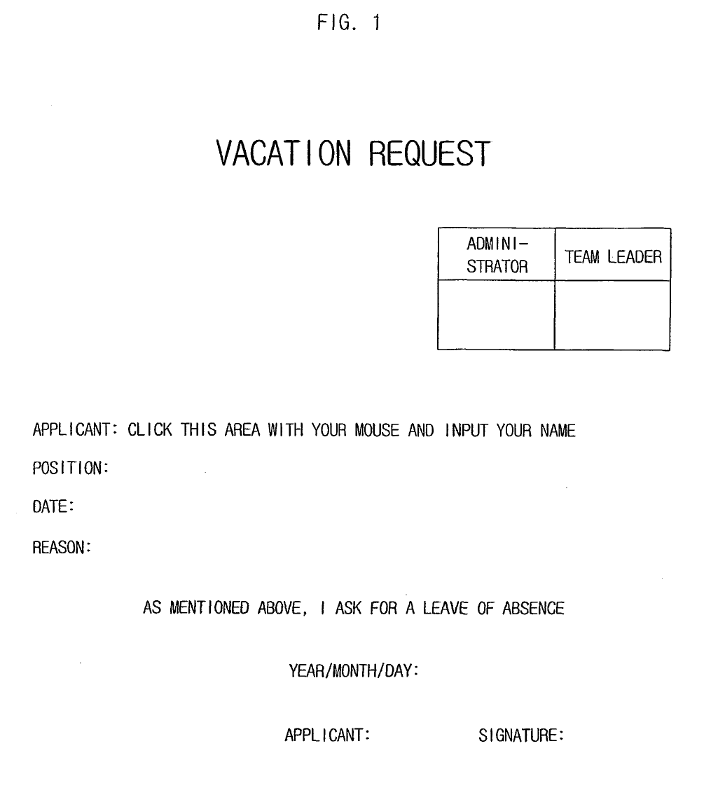

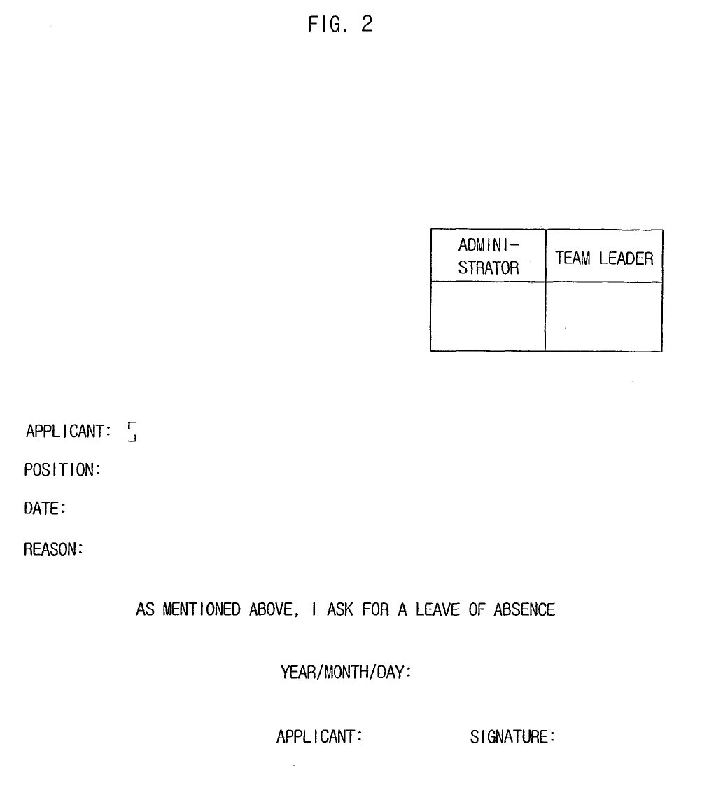

### DESIGNATION OF IMPORTANT COMPONENTS REPRESENTED IN THE ATTACHED DRAWINGS

110: user terminal

120: form management server

130: receiving part

140: control part

150: original form and manual storing part

160: transmitting part

170: data storing part

### DETAILED DESCRIPTION OF THE PREFERRED EMBODIMENTS

Hereinafter, preferred embodiments of the present invention will be described in more detail with reference to the accompanying drawings.

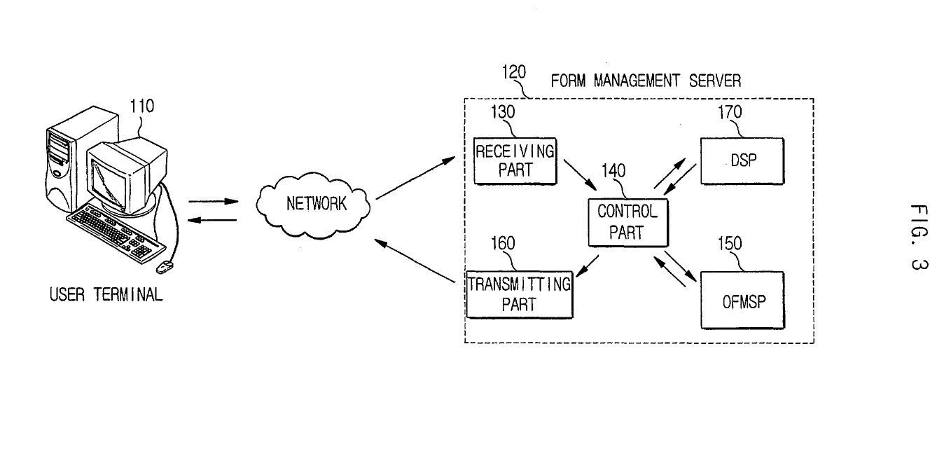

FIG. 3 is a partial front isometric, partial block diagram of a form-generating system by using network in accordance with one preferred embodiment of the present invention.

With reference to FIG. 3, the form-generating system comprises a user terminal 110 and a form management server 120. The form management server 120 can comprise a receiving part 130, a control part 140, an original form and manual storing part (hereinafter referred to as OFMSP) 150, a transmitting part 160 and a data storing part (hereinafter referred to as DSP) 170.

In FIG. 3, only a personal computer as the user terminal 110 is illustrated. But, in practice, all kinds of user terminal (e.g., a personal digital assistant, a mobile and the like), which can be inputted a text by user and connect to the form management server 120 through a network, can be applied without limit.

But, hereinafter, the form-generating system will be described with an case that the user terminal 110 is the personal computer in order to be clear the present invention.

From now on, the present invention will be briefly described by referring to FIG.3.

For example, when a member of a web site for electronic commerce requests a purchase transaction, an inventory and so on, the request goes out from the user terminal 110 to the form management server 120 by using the Internet (HTTP) protocol.

In the form management server 120, the receiving part 130 receives the request from the user terminal 110, the control part 140 retrieves a pre-stored original form. And the manual (i.e., manual information) corresponding to the request in the OFMSP 150, and the transmitting part 160 transmits the retrieved original form and the retrieved manual information to the user terminal 110 through the network.

The member fills out the relevant information (i.e., input data) in the blank fields (or detail) of the original form by referring to the manual information displayed on a display part coupled to the user terminal 110, such as a cathode ray tube (CRT) or liquid crystal display (LCD) screen. And then, the user terminal 110 transmits the inputted information by the member to the form management server 120 through the network.

In the form management server 120, the receiving part 130 receives the inputted information from the user terminal 110 through the network, the control part 140 stores the inputted information in the DSP 170.

The OFMSP 150 and the DSP 170 of the form management server 120 can be separated (in FIG. 3), or be integrated into one storing section (not shown).

As described above, if the OFMSP 150 and the DSP 170 are integrated into one storing section, the inputted information received from the user terminal 110 can be stored along with the related original form in the same field of the one storing section.

Needless to say, if each of the information received from the user terminal 110 has relevant code number as well as the user information and has the same code number as the related original form's, this case will be same result as above mentioned although the inputted data and the related original form are stored respectively.

Also, in case that the OFMSP 150 and the DSP 170 of the form management server 120 are separated, it will be same result by using aforementioned method.

Thus, when the user inputs ‘file open’ command for displaying an original form, the form management server 120 retrieves the related manual information by using the code number of the original form. And then, the form management server 120 retrieves the inputted data corresponding to the original form by using the user information and the code number although the original form, the manual and the inputted data are stored respectively. And then, the form management server 120 transmits a completed form including the original form and the inputted data to the user terminal 110.

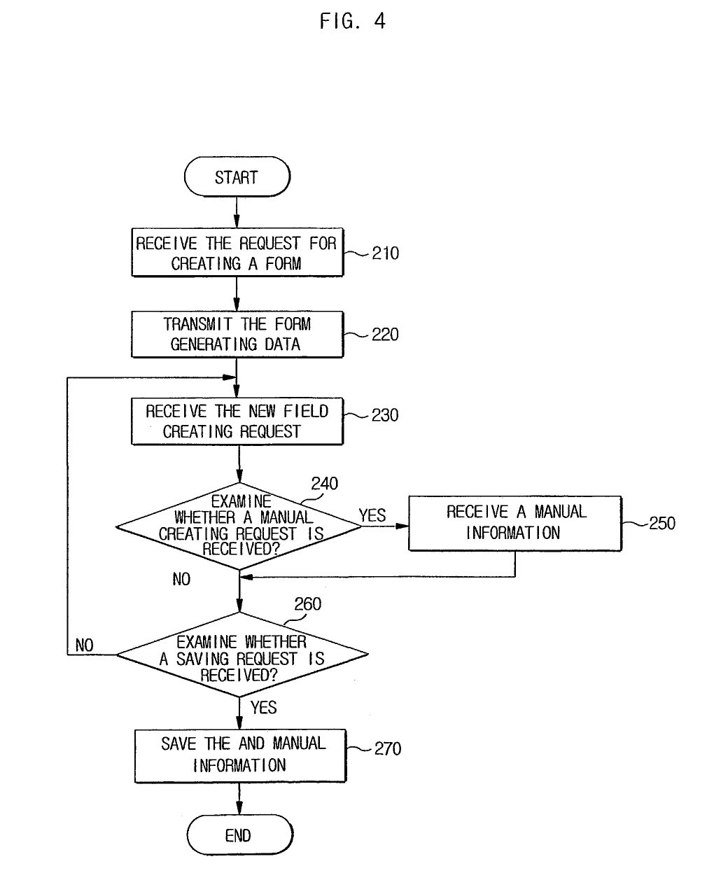

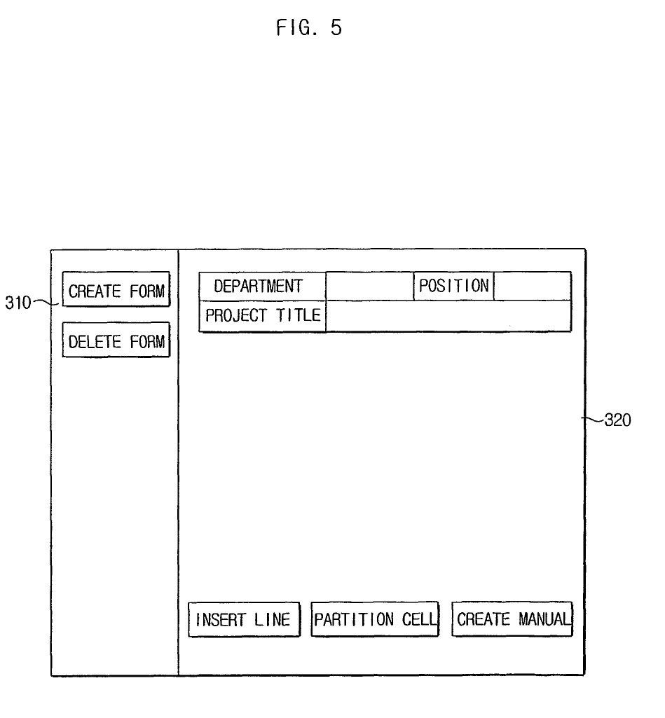

FIG. 4 is a flow chart illustrating form-generating process for creating a form including manual information and FIGS. 5, 6 and 7 illustrate a form-generating window for creating a form including manual information in accordance with one preferred embodiment of the present invention.

In this figure, the same reference numerals will be employed for denoting the same parts shown in FIG. 3, and detailed descriptions thereof are omitted.

With reference to FIG. 4, at step 210, the form management server 120 receives the request for creating a working form including manual function from the user terminal 110. That is, the working form comprises an original form and manual information corresponding to the original form. At step 220, the form management server 120 transmits the form generating data (i.e., a form creating web page for creating a form by the user) to the user terminal 110 through the network.

At step 230, the form management server 120 receives the new field creating request from the user terminal 110.

With reference to FIG. 5, the form creating web page, which is received from the form management server 120 in order to create a working form including a manual function, can comprise a menu selection section 310 and a form creating section 320.

The menu selection section 310 can comprise a ‘create form’ button, a ‘delete form’ button.

The form creating section 320 is the section for displaying an original form created by the user. The user (i.e., form-creator) can create, edit or improve the original form with a ‘insert line’ button, a ‘partition cell’ button, a ‘delete line’ button (not shown) and a ‘merge cell’ button (not shown) of the form creating section 320 in FIG. 5.

Returning to FIG. 4, whenever the form management server 120 receives the new field creating request (or field deleting request and so on) from the user terminal 110 through step 230, the form management server 120 creates a relevant field (e.g., a new line) in the form creating section 320 (shown in FIG. 5).

At step 240, the form management server 120 examines whether or not a manual creating request for creating newly a new field (such as a cell) is received from the user terminal 110.

If the manual creating request is received from the user terminal 110, the process proceeds to step 250 and the form management server 120 receives manual information corresponding to the newly created field from the user terminal 110 through the network. And then, the process proceeds to step 260. But, if the manual creating request is not received, the process proceeds directly to step 260.

With reference to FIG. 5 again, the original form, which is being created now by user (i.e., form-creator), is displayed in the form creating section 320.

The form management server 120 can recognize the difference between information designation field and information input field. The information designation field denotes a cell containing arbitrary information (such as a text or an image) in the cells of the original form. And the information input field denotes a cell containing blank in the cells of the original form.

Thereby, when the user (i.e., either form-creator or form-user) selects a cell containing information, a dialogue box for inputting the manual information corresponding to the cell (i.e., the information designation field) can be displayed on the display part of the user terminal 110.

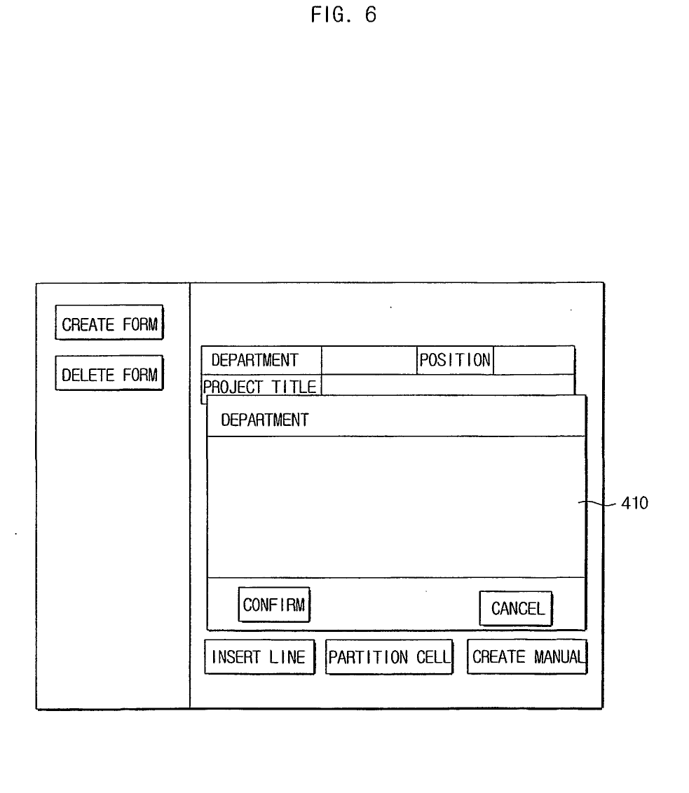

For example, when the user selects the ‘department’ among the information designation fields, a working window like FIG. 6 is displayed on the display part or the user terminal 110.

With reference to FIG. 6, a dialogue box, which includes an identification data corresponding to the selected information designation field, is displayed on the display part.

When the user inputs the manual information and presses the ‘confirm’ button with an input part such as a mouse, the manual information can be saved and be linked with the relevant information designation field.

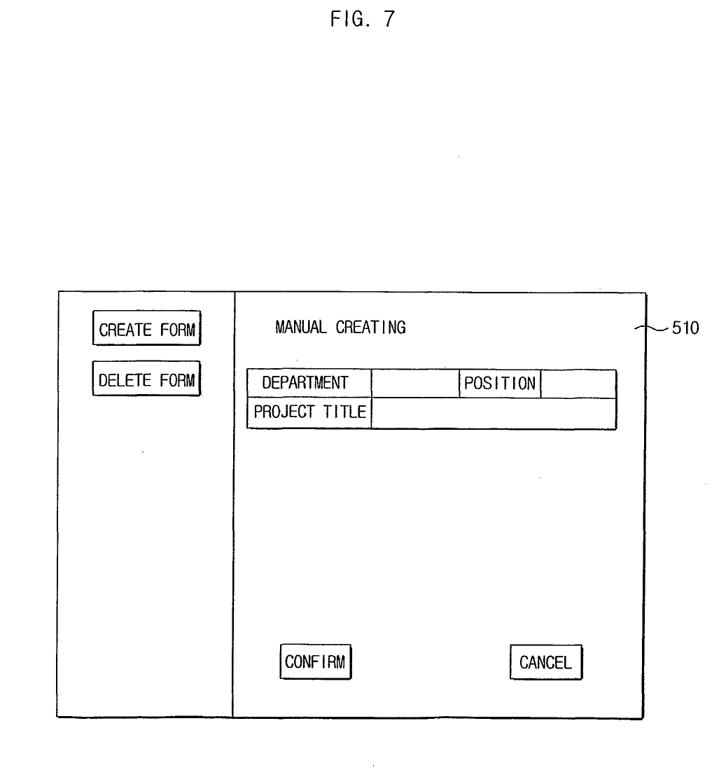

According to the present invention, the user can input the manual information in regular sequence as shown in FIG. 6. Also, the user can input the manual information in a lump (see FIG. 7)

Returning to FIG. 5, the original form, which is creating now by user, is displayed in the form creating section 320.

When the user completes the formation of the form or is under creating of the form, if the user presses the ‘create manual’ button in the form creating section 320 with the input part such as a mouse, a working window illustrated in FIG. 7 is displayed on the display part of the user terminal 110.

With reference to FIG. 7, a manual creating section 510, which includes the original form created by using the method described in FIG.5, is displayed on the display part.

When the user inputs arbitrary manual information in the information input field, if the user presses the ‘confirm’ button with an input part such as a mouse, the manual information can be saved and be linked with the relevant information designation field by referring to the information designation fields and the information input fields in the form.

And, the user can input manual information selectively or in a lump in the information input fields by using the manual creating section 510.

Also, in addition to the method described by referring to FIG. 5 through FIG. 7, the other methods for linking with the form and the manual information can be applied without limit.

Returning to FIG. 4, at step 260, the form management server 120 examines whether or not a saving request for saving the form is received from the user terminal 110.

If the saving request is received from the user terminal 110, the form management server 120 recognizes the completion of creating the form and saves the form and manual information (step 270). And if the saving request is not received, the process proceeds to step 230.

And, it goes without saying that the form and manual information can be revised by the user's request after the form and manual information are saved.

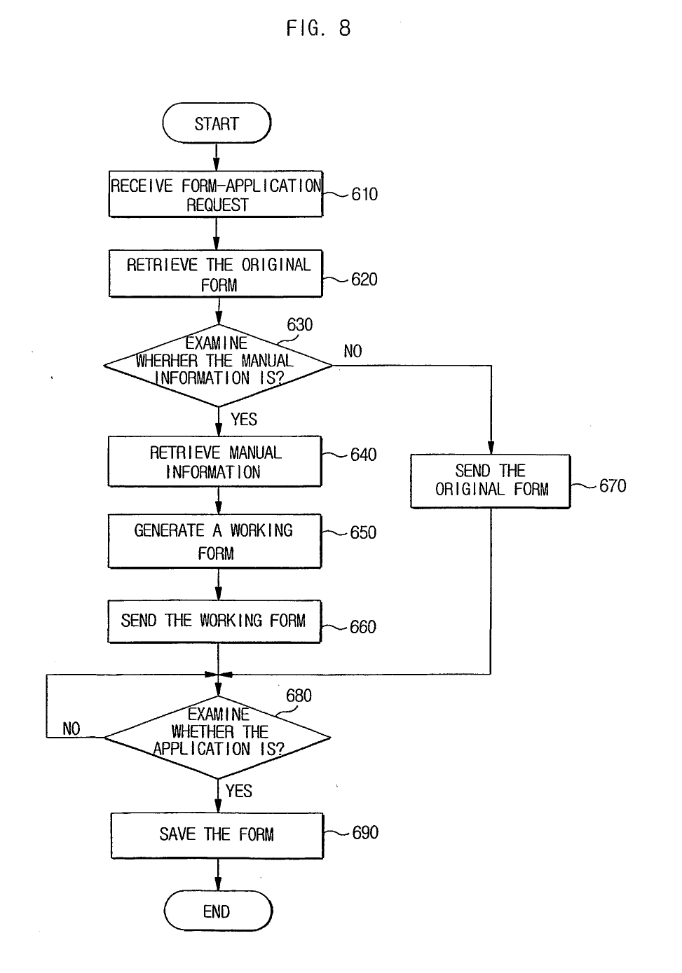

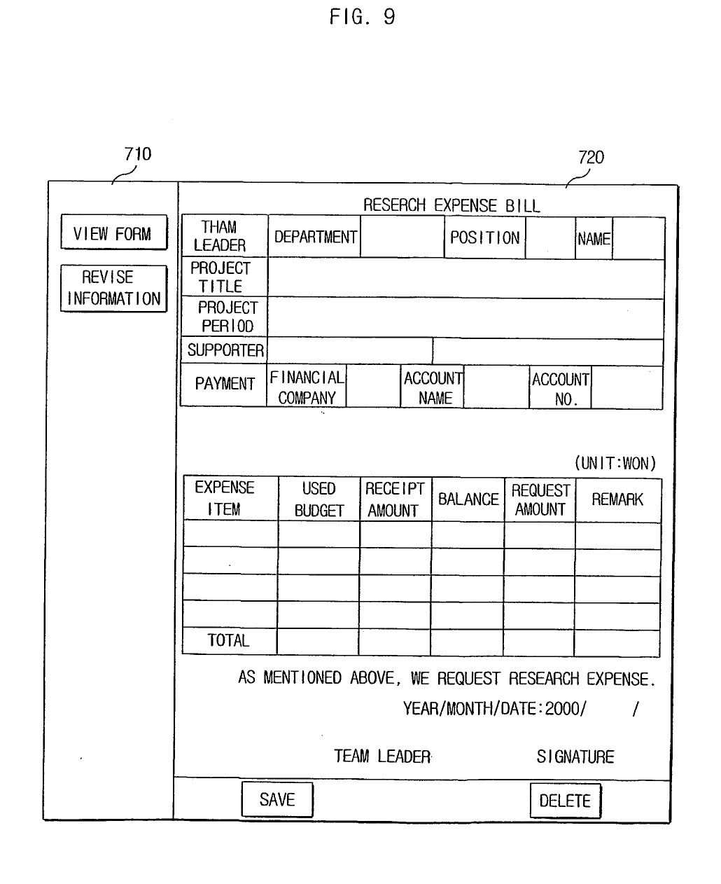

FIG. 8 is a flow chart for explaining a form-selecting process for utilizing a form including manual information and FIGS. 9, 10 and 11 illustrate a form-application window for utilizing a form including manual information in accordance with another preferred embodiment of the present invention.

With reference to FIG. 8, the form management server 120 receives a form application request in order to use an original form from the user terminal 110 through the network (step 610) and retrieves the original form corresponding to the form application request from the OFMSP 150 (shown in FIG. 3) (step 620).

At step 630, the form management server 120 examines whether or not the manual information corresponds to the original form. And if the manual information is found, the process proceeds to step 640. Otherwise, the process proceeds to step 670.

At step 640, the form management server 120 retrieves the manual information corresponding to the original form from OFMSP 150.

As mentioned above, the original form and the manual information corresponding to the working form can be stored within separate databases or within a unified database.

At step 650, the form management server 120 generates a working form (examples are disclosed in FIGS. 9, 10 and 11.) with the original form retrieved through step 620 and the manual information retrieved through step 640.

At step 660, the form management server 120 sends the working form to the user terminal 110 through the network and the process proceeds to step 680.

Returning to step 630, if the manual information corresponding to the original form is not found, the form management server 120 sends the original form retrieved through step 620 to the user terminal 110 through the network (step 670).

At step 680, the form management server 120 examines whether the application of the working form is ended or not by using inputted information, which inputted information for being inputted in information input fields of the working form is received from the user terminal 110.

When the form management server 120 sends the working form to user terminal 110 through the network (see step 660 or step 670), an example of a form-application window for utilizing a working form is disclosed in FIG. 9 as a display to illustrate what the user sees on the display part of the user terminal 110.

With reference to FIG. 9, the form-application window for utilizing a working form (i.e., the form creating web page) can comprise a menu selection section 710 and an information input section 720.

The menu selection section 710 can comprise buttons (such as ‘view form’ for displaying a original form, ‘revise information’ for revising an inputted information and so on.) for executing predetermined functions (such as revising the inputted information, saving, revising original form and the like). By user's selection in the menu selection section 710 of the screen, a relevant effect appears in the information input section 720.

As mentioned above (see FIG. 4 through FIG. 7), the information input section 720 is for displaying the original form. The user can create a completed form by inputting relevant information in the information input fields with reference to the relevant information designation fields.

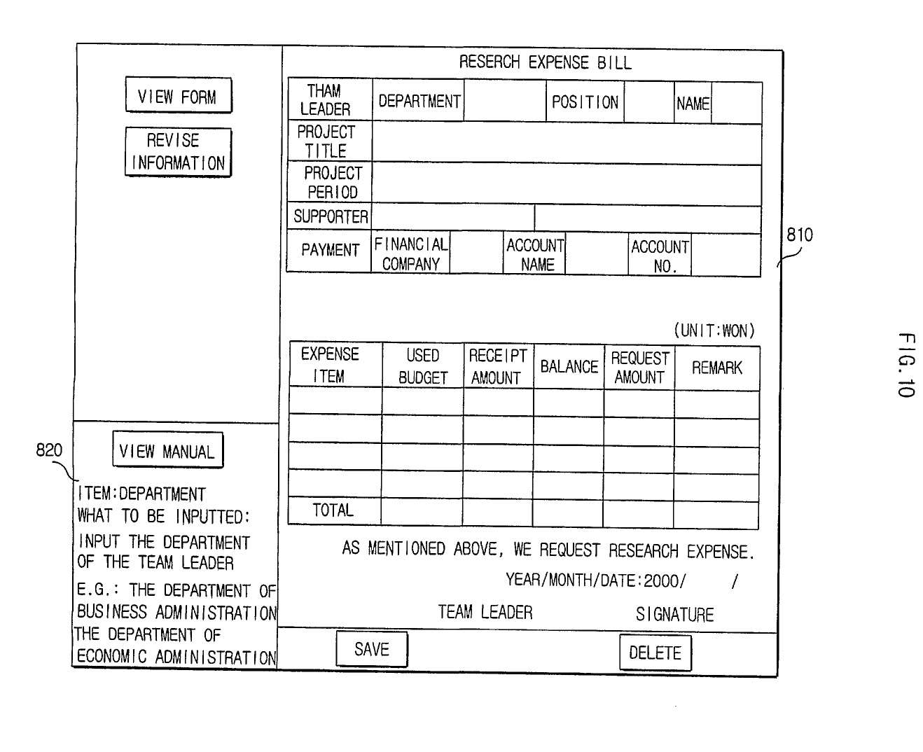

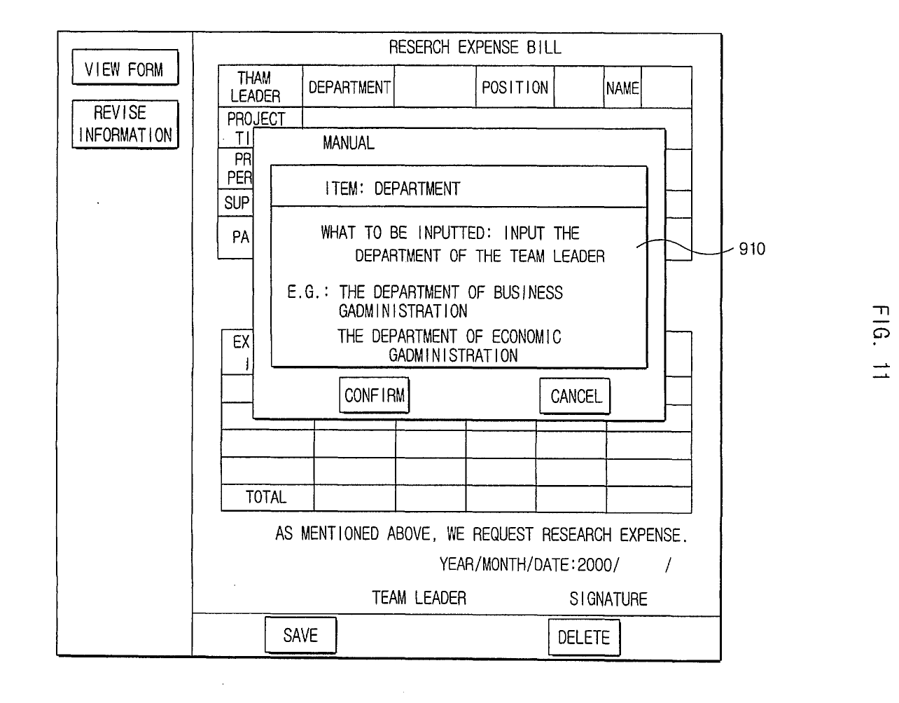

Hereinafter, the working form displayed in the information input section 720 will be described with reference to FIG. 10 and FIG. 11.

Examples of a form-application window including manual information are disclosed in FIG. 10 and FIG. 11 as a display to illustrate what the user sees on the display part of the user terminal 110.

That is, the working form displayed in the information input section 720 consists of an original form and the manual information corresponding to the original form. And the manual information can be displayed in a predetermined section of the form-application window by user's request.

With reference to FIG. 10, the form-application window can comprise the menu selection section, the information input section 810 and a manual information display section 820.

The original form displayed in the information input section 810 can comprise a plurality of information designation fields and information input fields.

The user inputs relevant information in the information input field by referring to the related information designation field (e.g., a name, a position, a division and the like).

In this case, when the cursor position is located in arbitrary information input field, the manual information corresponding to the information input field can be automatically displayed in the manual information display section 820. Also, when the cursor position is located in arbitrary information designation field, the manual information corresponding to the information designation field can be automatically displayed in the manual information display section 820.

And, as shown in FIG. 11, the manual information display section 820 can be not included in the form-application window. That is, the manual information can be displayed in a separate dialogue box 910.

Also, it goes without saying that any other methods for displaying the manual information by the user's request can be allowed virtually without limit.

The manual information display section 820 is a section for illustrating and explaining exemplary sample (i.e., a method for inputting relevant information, a sample of inputted information and the like), which is inputted by the user during he creates a form.

As mentioned above, it goes without saying that a form creator can revise the manual information displayed in the manual information display section 820.

According to another preferred embodiment of the present invention, a form management program comprising manual function is disclosed, which the form management program is installed and executed on the user terminal 110.

The form management program is that a user can use for creating a form, for example, word processor (e.g., Microsoft Word, HANGEUL and the like), a spreadsheet (erg., Microsoft Excel, Lotus and the like), web-page design tool (e.g., Netscape Visual JavaScript, Microsoft FrontPage and the like) and the like.

According to the present invention, there are several methods for adding the conventional form-management program to manual function as below.

One method is that the user adds the manual function to the conventional form-management program by using storage media (e.g., CD-ROMS, floppy disks, magnetic tapes and the like) produced for the purpose of upgrading the conventional form-management program.

Another method is that the user installs the up-to-date form-management program including the conventional form-management function and the manual function once more.

Hereinafter, the present invention will be described with priority given to the form management program, which the form management program comprises manual function and is installed on the user terminal 110.

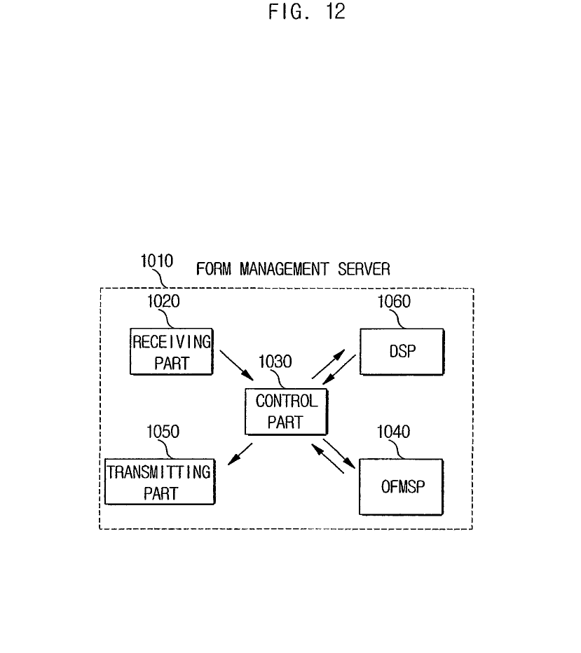

FIG. 12 is a block diagram of a form management system in the shape of a stand-alone type in accordance with still another preferred embodiment of the present invention.

With reference to FIG. 12, a form management system 1010 comprises a receiving part 1020, a control part 1030, an original form and manual storing part (hereinafter referred to as OFMSP) 1040, a transmitting part 1050 and a data storing part (hereinafter referred to as DSP) 1060. The form management system 1010 is the shape of being installed the form management program in the user terminal 110.

The receiving part 1020 of the form management system 1010 receives an original form open request, which the original form open request is inputted with an input part (not shown) such as a keyboard, a mouse and the like. The control part 1030 retrieves a working form corresponding to the original form open request from the OFMSP 1040. The transmitting part 1050 transmits the working form to a display part (not shown) coupled to the user terminal 110. The display part displays the working form on the screen of the user terminal 110.

When the user inputs relevant information by referring to the working form (i.e., an original form and manual information corresponding to the original form) with the input part, the inputted information is received through the receiving part 1020.

The receiving part 1020 of the form management system 1010 receives the inputted information inputted with the input part, and the control part 1030 stores the inputted information in the DSP 1060.

As mentioned above, the OFMSP 1040 and the DSP 1060 of the form management system 1010, can be separated as shown in FIG. 12, or be integrated into one storing section (not shown).

After the user installs the form management system 1010 (i.e., form management program) on the user terminal 110, the step for creating a working form and inputting the relevant information by referring to the working form is similar to the aforementioned step by using the network. Therefore, the step will be described again with FIG. 4 and FIG. 8.

First, the method for adding manual information to arbitrary original form will be described by referring to FIG. 4.

The form management system 1010 receives the original-form open command from the input part (not shown), displays the form-generating window corresponding to the original-form open command on the screen or the user terminal 110.

Then, the user can input the original-form open command using a predetermined icon for opening an original form, a predetermined function key (e.g., ‘Ctrl+M’) and so on.

The form-generating window displayed on the screen of the user terminal 110 can be empty window in order to be created an original form by the user. And if an initial form is displayed in the form-generating window, the user can set to be linked the initial form to relevant manual information.

And, when the new field creating command such as a line inserting, a cell partitioning, a line deleting, a cell merging and the like are received, the form management system 1010 executes the relevant process for displaying a form-revising window on the screen of the user terminal 110. And, if a manual-creating command is received from the input part, the manual creating process can be proceeded using the aforementioned method described by referring to FIG. 5 through FIG. 7.

And, if the user inputs a save command for storing a created form, the form management system 1010 stores the created form in the OFMSP 1040. Then, if the user inputs an open command for displaying a original form, the form management system 1010 retrieves the created form corresponding to the open command and executes the relevant process for displaying the created form on the screen of the user terminal 110.

Second, the method for using a working form (i.e., an original form comprising manual function) will be described by referring to FIG. 8.

When receiving a working-form open command from the input part, the form management system 1010 retrieves the working form corresponding to the working-form open command from the OFMSP 1040 and executes the relevant process for displaying the working form (i.e., an original form and manual information corresponding to the original form) on the screen of the user terminal 110.

Then, the original form and the manual information can be displayed all at once on the screen of the user terminal 110.

Also, as mentioned above, only the original form is displayed on the screen of the user terminal at first. Then, when the user selects one of the information designation fields in the original form displayed on the screen of the user terminal 110, the manual information corresponding to the selected information designation field can be displayed on the screen of the user terminal 110.

And, It goes without saying that any other methods for displaying the manual information on the screen of the user terminal by the user's request can be allowed without limit.

And, when the user inputs relevant information by referring to the working form (i.e., the original form and the manual information corresponding to the original form) and a save command with the input part, the form management system 1010 stores the working form and/or the inputted information in the DSP 1060.

In case that the working form, created by the form management system of the first user, provides to the second user, the working form (e.g., a original form along with manual information corresponding to the original form) can be provided to the second user.

For example, the methods for providing the working form to second user are as follows.

One method is that the first user provides working form itself in the shape of one electronic file to second user.

Another method is that the manual information is automatically provided to the second user, when the first user provides an original form to the second user, because the manual information is coupled to the original form.

Still another method is that the first user provides an original form and the manual information corresponding to the original form in the shape of separate electronic file.

And, when the second user inputs relevant information by referring to the original form and the manual information corresponding to the original form, the inputted information can be saved or provided in the shape of being linked to the original form and the manual information corresponding to the original form.

Also, when the second user inputs relevant information using the working form, if the form management system 1010 generates the each ID code for inputted information, only the inputted information can be saved independently. Because, when the inputted information are displayed on the screen of the user terminal 110, the form management system 1010 can retrieve the original form corresponding to the ID code, enter into the inputted information in the relevant information input field of the original form and display the inputted information and the original form simultaneously on the screen of the user terminal 110.

For example, in case that the form-management program is HANGEUL (Korean word processor), a form management system comprising the manual function will be described with reference to the attached drawings.

First, the method for creating a working form comprising manual function will be described. Second, the method for creating a working form comprising only text data and the method for creating a working form comprising text data and table data will be described.

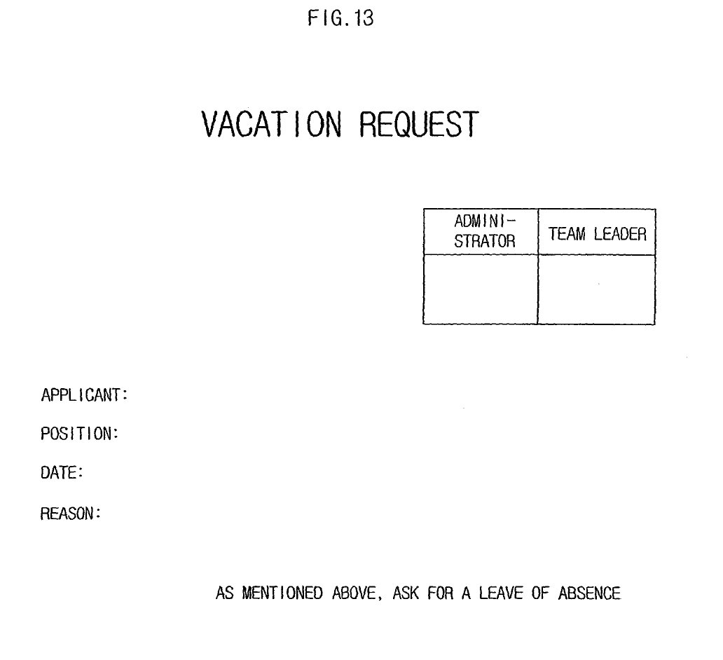

FIGS. 13, 14, 15, 16 and 17 illustrate a form-application window for utilizing a form including manual information in accordance with still another preferred embodiment of the present invention.

That is, FIGS. 13 through FIG. 17 show a form-application window for creating form comprising manual function, which form is a vacation request for being allowed him to take a vacation.

With reference to FIG. 13, a vacation request displayed in the form-application window does not have corresponding manual information yet.

The methods for adding manual function to the vacation request are as follows.

One method is that the manual function is added to the vacation request by selecting each word, phrase or paragraph the user wants to link to the manual information.

Another method is that the manual function is added to the vacation request by using predetermined key (e.g., ‘CTRL+K, M’) for adding to manual function at a cursor position where the user want to link to the manual information.

Still another method is that the manual function is linked to the zone from the first position to the second position, if the user inputs the predetermined key for inserting manual function two times.

Still another method is that the manual function is added to the vacation request by using the conventional NURMTLE function.

Also, the user can add the manual function to the vacation request while he is creating the vacation request or after he has created the vacation request.

With reference to the attached drawings, the aforementioned methods will be described.

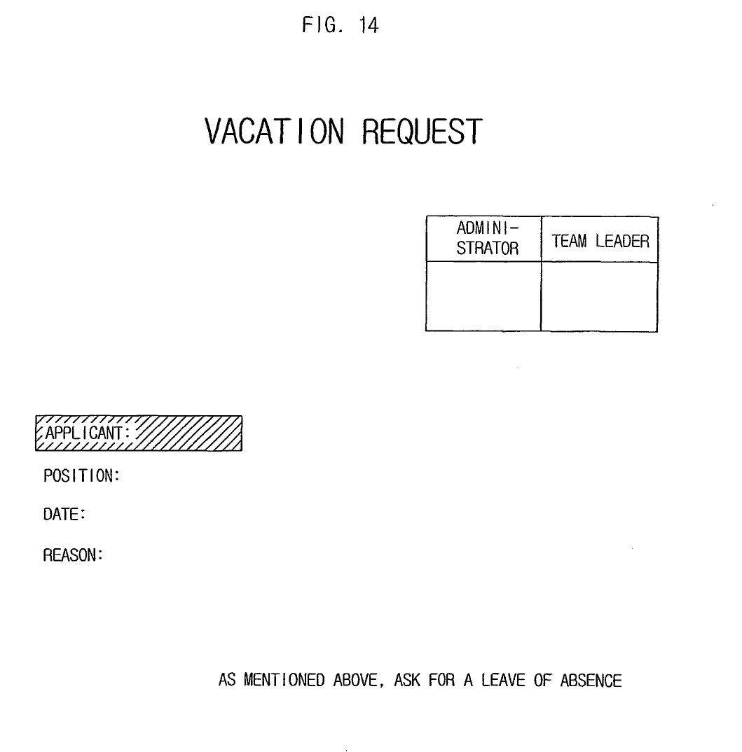

FIG. 14 illustrates the method for adding manual information to the vacation request by selecting each word, phrase or paragraph (i.e., using a block function) with a predetermined function key such as F3. And, FIG. 14 illustrates a working window, after the user selects composition mark on the View menu.

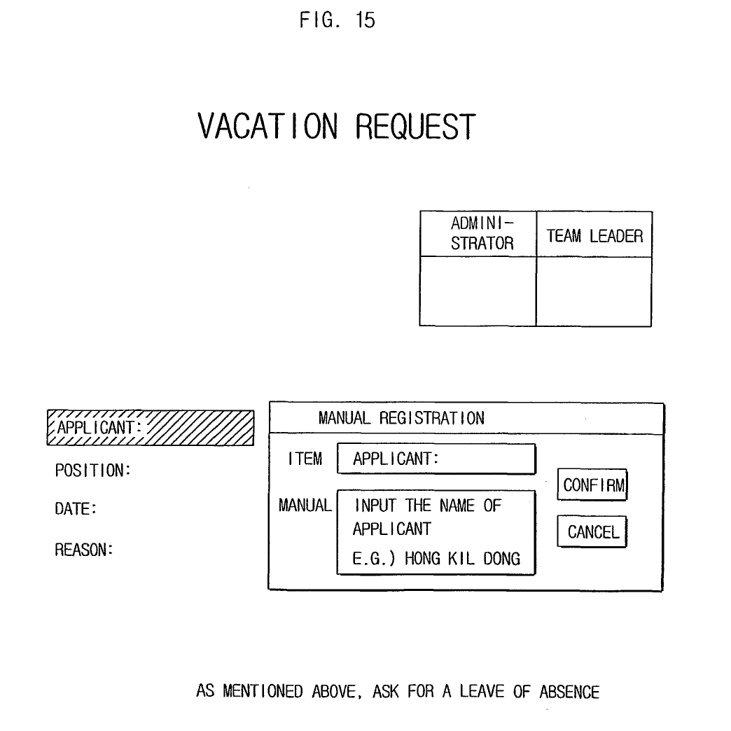

If the user establishes the block by selecting each item by using predetermined function key such as F3 in order to add the manual function to the vacation request and then inputs predetermined shortcut key (e.g., ‘CTRL+K, M’), a manual registration dialogue box, shown in FIG. 15, is displayed on the screen of the user terminal 110.

With reference to FIG. 15, the manual registration dialogue box comprises position information of the selected block (i.e., APPLICANT) and manual input area for being inputted manual information by user.

When the user inputs ‘Input applicant's name. e.g) Hong, Kil-dong’ in the manual input area and presses ‘confirm’ button, the manual information, inputted in the manual input area, corresponding to the selected block is linked to the vacation request

As described above, the manual information can be stored in the vacation request that is creating by user or in separated file automatically (i.e., file names of the vacation request and the manual information are same, but file extension of them are different).

Also, each of manual information corresponding to each item can be stored individually in the shape of separate file or totally in the shape of one file.

As described above, even if the manual information and the vacation request are stored individually in the shape of separate file, the composition mark, for example inserting manual, is inserted, but when the method for storing them in separate file is compared with the method for storing them in one electronic file, the stored position for storing the manual information and the information corresponding to the composition mark (i.e., manual insertion) are different. The composition mark is not displayed in the original form under the default condition, but when the user selects composition mark on the View menu, the composition mark is displayed such as ‘enter mark’ in the Microsoft word.

That is, in case that the manual information and the original form are stored individually in the separate file, the composition mark (i.e., manual insertion) comprises the stored position of the manual information (e.g., directory information and file name information for designating the stored position of the manual information) and the block information established by user (e.g., from 1 page 3 line 2 row to 1 page 3 line 10 row).

Also, in another method, whenever the user inserts manual inserting key, if ID code, for example personal information of the user, order information inputted the manual inserting key, generates automatically, the ID code can be used.

Also, in case that the manual information and the original form are stored individually in the separate file, the user uses the working form fully by being provided the original form along with the manual information.

In that case, the position information in the composition mark (e.g., manual insertion) is automatically renewed (e.g., by the method of retrieving manual information having the same file name). And, if the user opens the original form and then input predetermined manual renew key (e.g., ‘CTRL+K, L’), the manual information can be renewed in linking the manual information to the original form.

In case of using ID code, if the user opens the original form, the relevant manual information can be automatically linked to the original form in the directory storing plurality of manual information by retrieving the manual information having the same ID code.

When the user uses the working form created by the method shown in FIG. 14 and FIG. 15, if the cursor position is located in the predesignated block, the manual information inputted in the manual registration dialogue box, shown in FIG. 15, is automatically displayed on the screen of the user terminal 110.

The method for using the working form will be described later with reference to the related drawings.

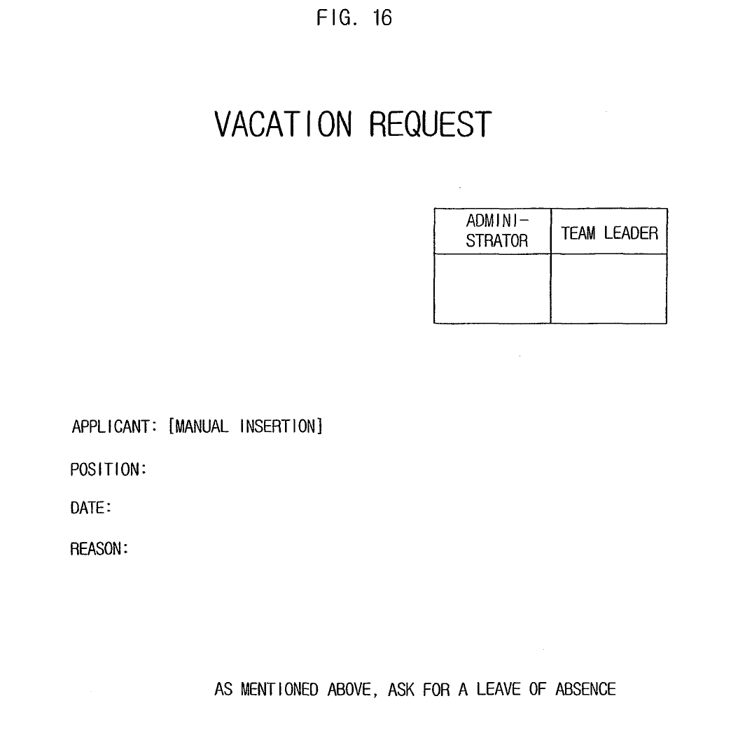

FIG. 16 illustrates the method to add manual information to the original form by using predetermined manual inserting key (e.g., ‘CTRL+K, M’) one time.

A form-application window inputted predetermined manual inserting key (e.g., “CTRL+K, M) in order to insert manual information is displayed in FIG. 16.

When the user inputs manual inserting key, a manual registration dialogue box (shown in FIG. 15) is displayed on the screen of the user terminal 110.

When the user inputs manual information by inputting manual inserting key one time, the composition mark (e.g., manual insertion) can comprise former enter position information (i.e., enter mark is composition mark for shifting to new line) and related enter position information (i.e., related enter mark is enter mark which is succeed to the position inputted the composition mark (e.g., manual insertion)).

So, if the cursor position is located in range from the former enter position to the related enter position on the basis of the position of the composition mark, the relevant manual information can be automatically displayed on the screen of the user terminal 110. The method for using the working form will be described later with reference to the related drawings.

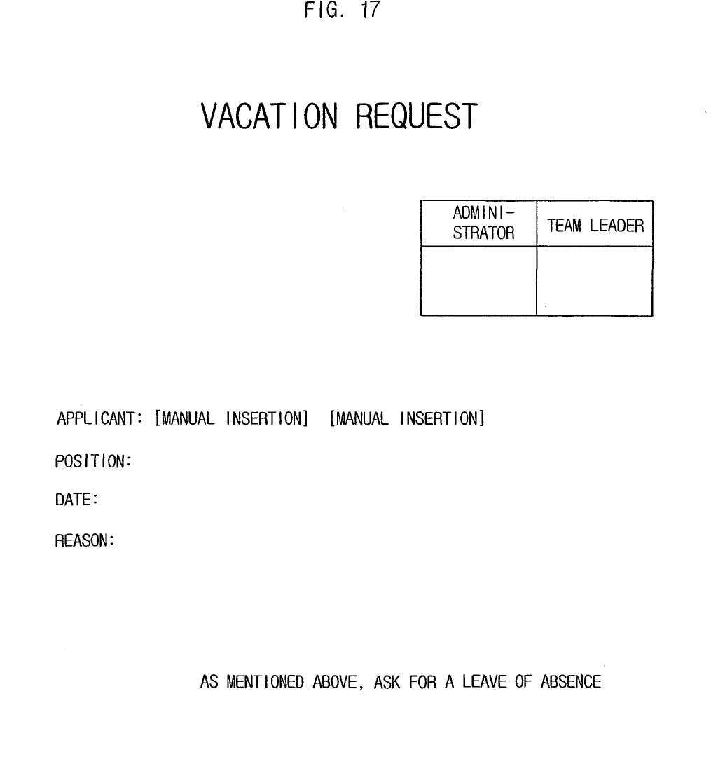

FIG. 17 illustrates the method to add manual information to the original form by using predetermined manual inserting key (e.g., “CTRL+K, M) two times.

A form-application window inputted predetermined manual inserting key (e.g., ‘CTRL+K, M’) two times at intervals in order to insert manual information is displayed in FIG. 17.

When the user inputs the first manual inserting key, a manual registration dialogue box (shown in FIG. 15) is displayed on the screen of the user terminal 110.

As shown in FIG. 17, the user inputs manual information after inputting the first manual inserting key, and then inputs the second manual inserting key at intervals. Then, the first manual inserting key can comprise start position information for applying manual function, the second manual inserting key can comprise end position information for applying manual function.

When the user wants to insert manual information at arbitrary position in the original form having text, the aforementioned method can be applied. For example, a vendee (manual application position) commits to purchase with the sum of (manual application position) won from vendor (manual application position).

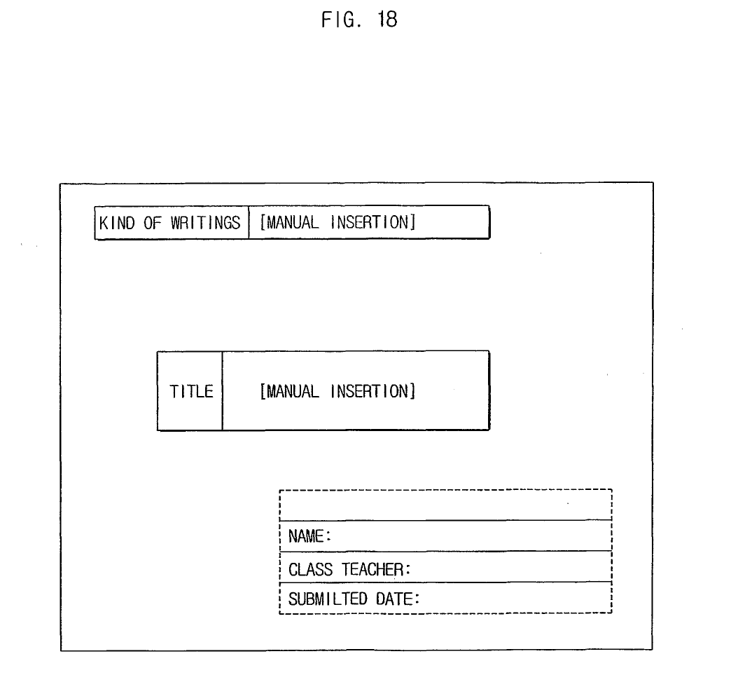

FIG. 18 illustrates a form-generating window for creating a form including manual information in accordance with still another preferred embodiment of the present invention.

Unlike the description by referring to FIG. 13 through FIG. 17, FIG. 18 shows a form-application window which comprises a original form having tables.

With reference to FIG. 18, a form-application window comprising a cover of document having tables is displayed on the screen of the user terminal 110.

If the user wants to create a cover of document and manual information having a sample, first the user creates necessary table in the original form, which table comprises a plurality of cells. And after the user inputs relevant information in a cell (i.e., information designation field) of the table, the user inputs manual inserting key in the information input field corresponding to the information designation field.

When the user inputs the manual inserting key, the manual registration dialogue box (shown in FIG. 15) is displayed on the screen of the user terminal 110.

Because the method for creating relevant manual information by using the manual registration dialogue box is already described, the same description will be omitted to avoid duplication.

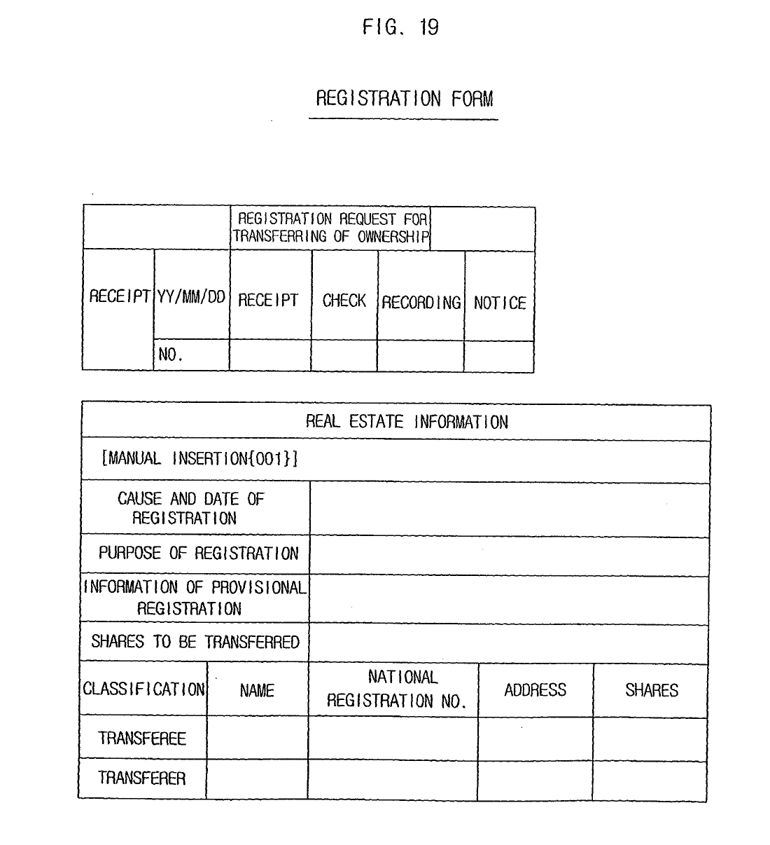

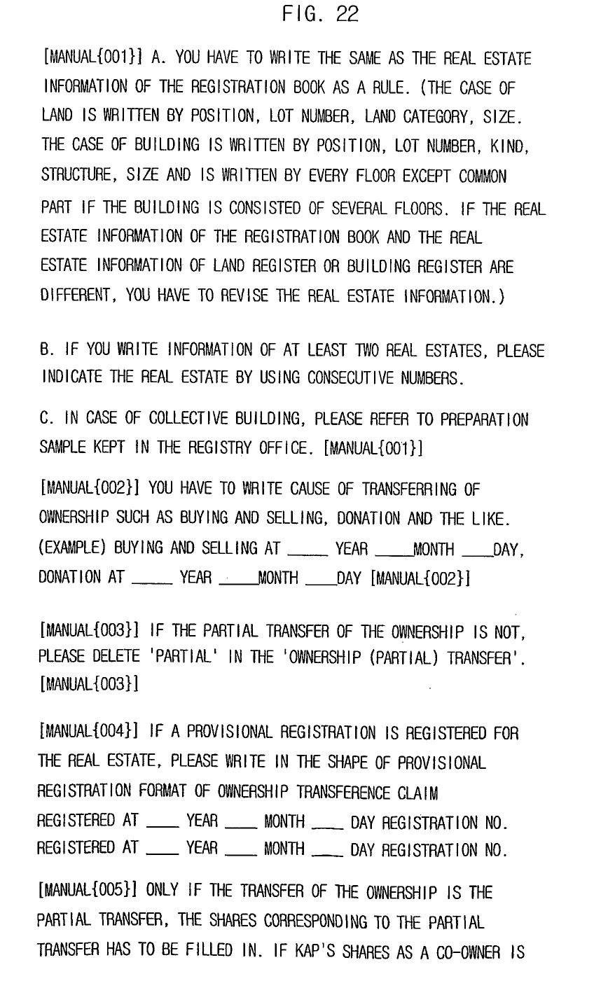

The method for inputting manual information corresponding to an item or a cell in the original form by referring to FIG. 13 through FIG. 18 will be described in full detail by referring to FIG. 19 and FIG. 22.

FIGS. 19, 20, 21 and 22 illustrate a form-generating window for creating a form including separated at least one manual information in accordance with still another preferred embodiment of the present invention.

FIG. 19 through FIG. 21 illustrate the original form linked to at least one manual information FIG. 22 illustrates at least one manual information linked to the original form. And, to meet the convenience of description, the present invention will be described with arbitrary form, for example, a registration form.

The plurality of manual information linked to the original form can be stored totally in one electronic file (shown in FIG. 22) or individually in separate electronic file.

With reference to FIG. 19, a registration form comprising ‘real estate information’, ‘cause and date of registration’, ‘purpose of registration’ and the like is displayed on the screen of the user terminal 110.

The registration form, shown in FIG. 19, comprises tables and first user (i.e., a form-creator) can insert relevant manual information (e.g., how to use the registration form) corresponding to the information designation field in order to help second user (i.e., a form-user) to be useful.

The manual information can be inputted on the basis of the position of the information input field, the position of the selected block comprising the information input field and the relevant information designation field, or the position of the information designation field only.

FIG. 19 illustrates the step for inputting manual information in the information input field corresponding to the ‘real estate information’. And, the manual information provides the form-user with information (e.g., what to be inputted in the in information input field corresponding to ‘the real estate information’).

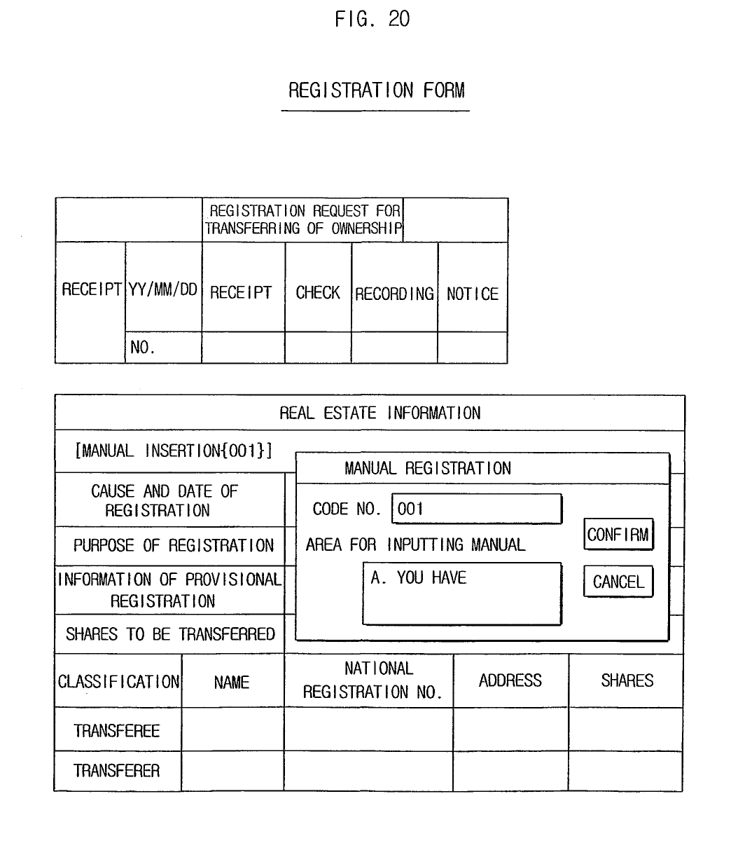

That is, if the form-creator inputted predetermined manual inserting key (e.g., ‘CTRL+K, M’) in the information input field corresponding to the ‘real estate information’ for creating the registration form, a manual registration dialogue box (shown in FIG. 20) is displayed on the screen of the form-creator's terminal 110.

With reference to FIG. 20, the manual registration dialogue box can comprise code number and manual input area.

Whenever the form-creator inputs the predetermined manual inserting key, the code number can be automatically generated in order. Also, according to another method for creating code number, the user can input the code number one by one.

And, if the user inputs relevant manual information in the manual input area and press the ‘confirm’ button with input part such as a mouse, the manual information corresponding to the information input field is created. And, in the information input field, the composition mark and the code number of the manual information can be displayed. As described above, the composition mark and the code number of the manual information can be displayed when the user selects composition mark on the View menu. The composition mark shows the existence of manual information corresponding to the information input field.

The code number can be omitted, if the manual information and the original form are not stored individually in separate file, but stored totally in one electronic file.

And, in case that the user wants to revise the created manual information, the created manual information can be revised by using the convention method for revising a numerical formula, table and the like in HANGEUL (Korean word processor).

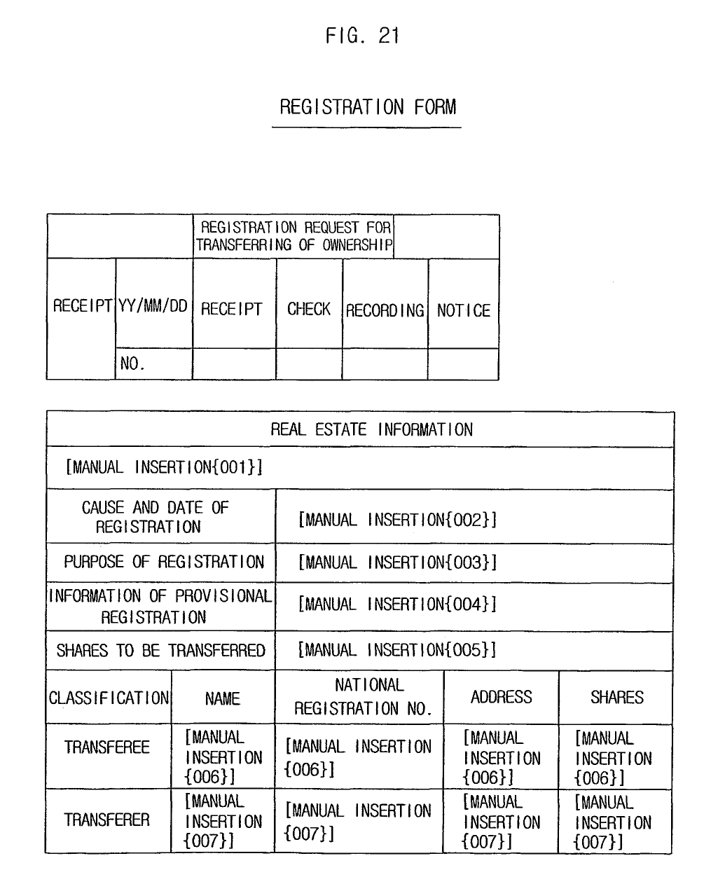

FIG. 21 illustrates the registration form that is finished by using the method described by referring to FIG. 19 and FIG. 20.

With reference to FIG. 21, the registration form having a plurality of information input field and information designation field is displayed on the screen of the form-creator terminal 110. Each of the information input field can be liked to each of the manual information.

Namely, each of the information input field can be linked to each of the manual information such as a ‘real estate information’, ‘purpose of registration’, ‘shares to be transferred’ and the like in FIG. 21. Also, the detail (e.g., a name, a national registration number) of the information designation field such as ‘transferee’ can be linked to the manual information.

There are several methods for being linked a plurality of items to same manual information.

One method is that the user inputs predetermined manual inserting key en bloc, after selecting a plurality of cells as a block.

Another method is that the user input the same code number in the manual inserting area of the manual registration dialogue box (shown in FIG. 20) in order to be linked a plurality of cell to the same manual information.

FIG. 22 illustrates manual information that is linked to the registration form shown in FIG. 21.

With reference to FIG. 22, a plurality of manual information having each of manual code number is divided each of manual information by using the manual code number in shape of ‘[manual {code number}]’, but forms one document file.

Accordingly, when the cursor position is located in the information input field corresponding to ‘real estate information’ by user, the information input field is controlled by the composition mark such as ‘[manual insertion {001}]’. And the manual information corresponding to the ‘[manual {001}] can be displayed on the screen of the user terminal 110, by retrieving manual information corresponding to the ‘[manual insertion {001}]’ in the stored manual information.

That is, when the cursor position is located in the information input field corresponding to ‘real estate information’, the manual information (e.g., a. Fill in the blank by referring to sample of the . . . form as a rule) is displayed in the pre-designated area.

A plurality of manual information illustrated in FIG. 22 can be inputted one by one whenever the user input the manual inserting key, or in a lump by using the ID code of manual information and an electronic file having a plurality of manual information.

In the same manner, when the user wants to revise the manual information, the manual information can be revised one by one at a presdesignated position in the form, or in a lump by using the electronic file having a plurality of manual information by user.

As described above, there are several methods for adding a form to manual information.

One method is that the user inputs the manual information in a manual registration dialogue box, which the manual registration dialogue box is displayed on the screen of user terminal 110 when the user inputs manual inserting key.

Another method is that the user inputs the manual information by a predetermined icon located in the form-generating window.

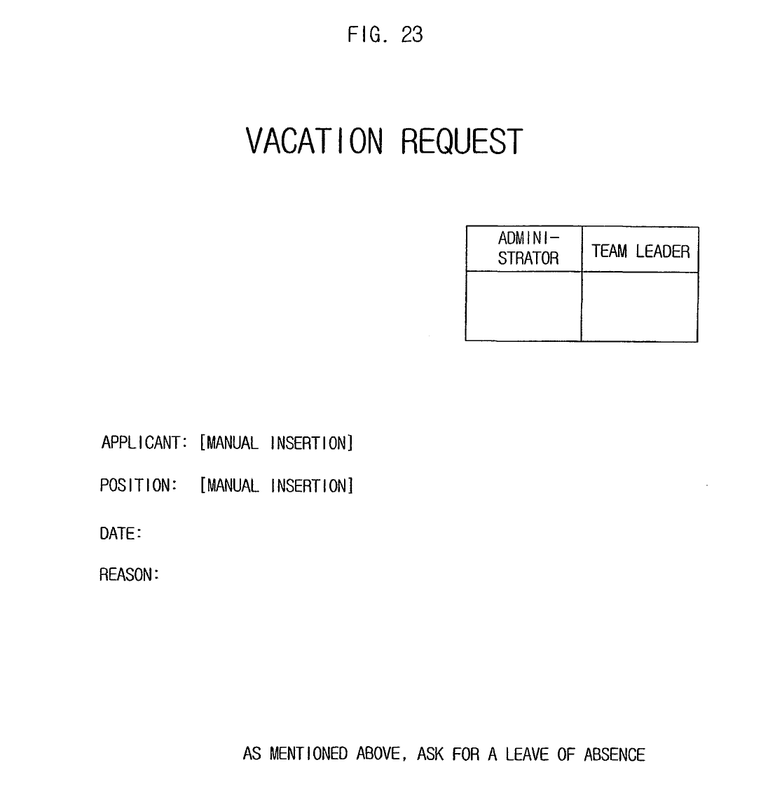

FIGS. 23, 24, 25 and 26 illustrate an auto fill-in window for inserting pertinent information automatically by user's selection in the predetermined choices in accordance with still another preferred embodiment of the present invention.

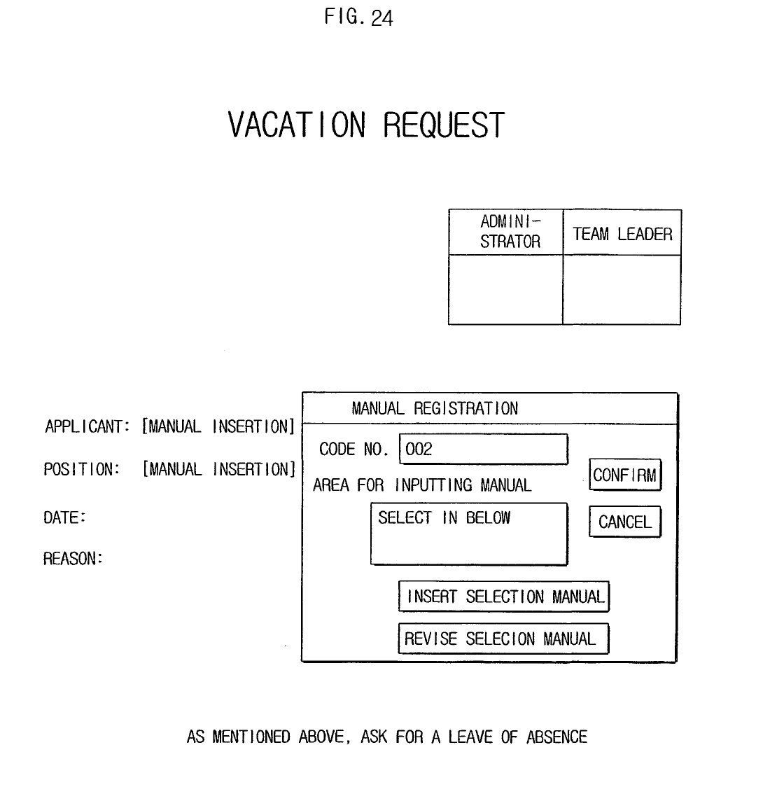

If a form-creator stored a plurality of selectable details in an item in advance, when a form-user selects a detail of the plurality of the selectable details, the method for inserting the manual information corresponding to the selected detail in the form will be described the specified form such as the vacation request shown in FIG. 23 and FIG. 24.

With reference to FIG. 23, the vacation request can comprise various shape of manual information.

That is, it goes without saying that each item such as ‘APPLICANT’ or ‘POSITION’ can comprise the manual information. The manual information can be the information trait to be required to be inputted in blank corresponding to the item, provided-in-advance preparation sample and the like.

Also, if the position classification (e.g., a president, a general manager, a deputy general manager, a department chief and the like) in place of the information trait and the provided-in-advance preparation sample, corresponding to the ‘POSITION’ item, is displayed on the screen of the user terminal 110, when the form-user selects a detail in the position classification, the selected detail can be automatically inserted in the predetermined location.

Hereinafter, the method for inserting pertinent position information automatically by user's selection in the predetermined location will be described.

When the form-creator selects the suitable location in the vacation request in order to input manual information corresponding to the ‘POSITION’ item (then, it is can also be allowed the aforementioned method described by referring to FIG. 14 through FIG. 17) and inputs the predetermined manual inserting key (e.g., ‘CTRL+K, M’), the manual registration dialogue box shown in FIG. 24 is displayed on the screen of the user terminal 110.

With reference to FIG. 24, the manual registration dialogue box comprises code number, manual input area, ‘insert selection manual’ button, and ‘revise selection manual’ button.

Because the manual registration dialogue box is already described by referring to FIG. 24, the same description will be omitted to avoid duplication.

The form-creator inputs manual information (e.g., Select one detail in below selectable details) corresponding to the selected item in the manual input area and presses ‘insert selection manual’ button with an input part such as a mouse.

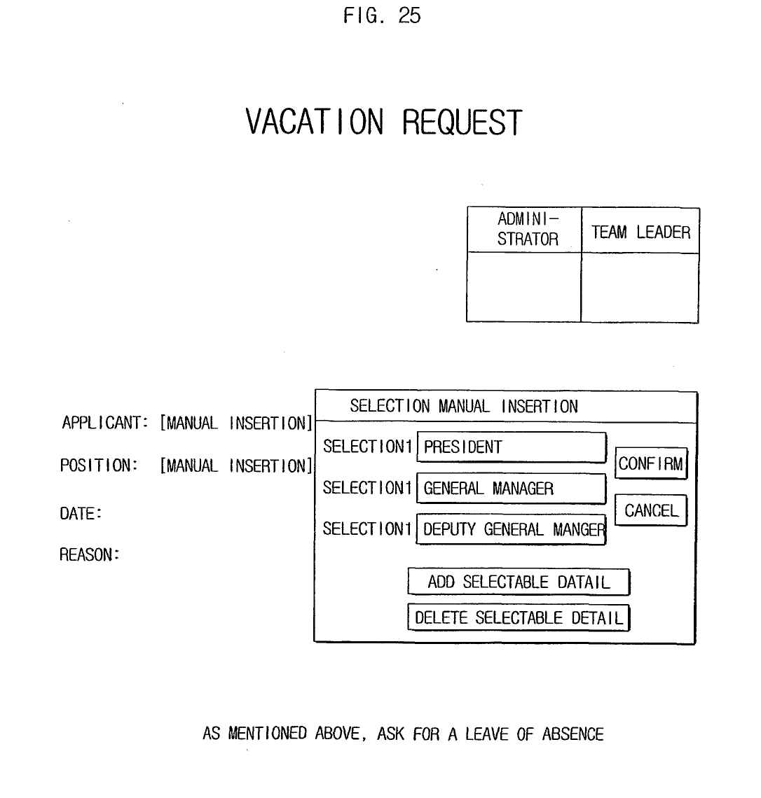

If the form-creator presses the ‘insert selection manual’ button with the input part, the selection manual inserting dialogue box shown in FIG. 25 is displayed on the screen of the user terminal 110.

With reference to FIG. 25, the selection manual inserting dialogue box comprises a plurality of selectable detail input fields, ‘add selectable detail’ button and ‘delete selectable detail’. The selection manual inserting dialogue box further comprises ‘add other detail’ button for adding a detail except the presented item.

Information, that the form-creator wants to present as a selectable detail, can be inputted in the selectable detail input fields. That is, because the selection manual dialogue box shown in FIG. 25 requires inputting the title of the position, the form-creator can input the pertinent titles of the position, for example, a president, a general manager and a deputy general manager. And, if the form-creator presses the ‘add selectable detail’ button with the input part such as a mouse in order to input more titles of the position, additional selectable detail input field is generated in the selection manual inserting dialogue box.

As described above, if the form-creator inputs the selection manual by using the method shown in FIG. 23 through FIG. 25, when the form-user inputs pertinent information in the vacation request, a plurality of selectable details are displayed on the screen of the form-user's terminal 110. And then, if the form-user selects any detail, the manual information corresponding to the selected detail is automatically inputted in the vacation request.

The method for using the selection manual will be described later with reference to the related drawings.

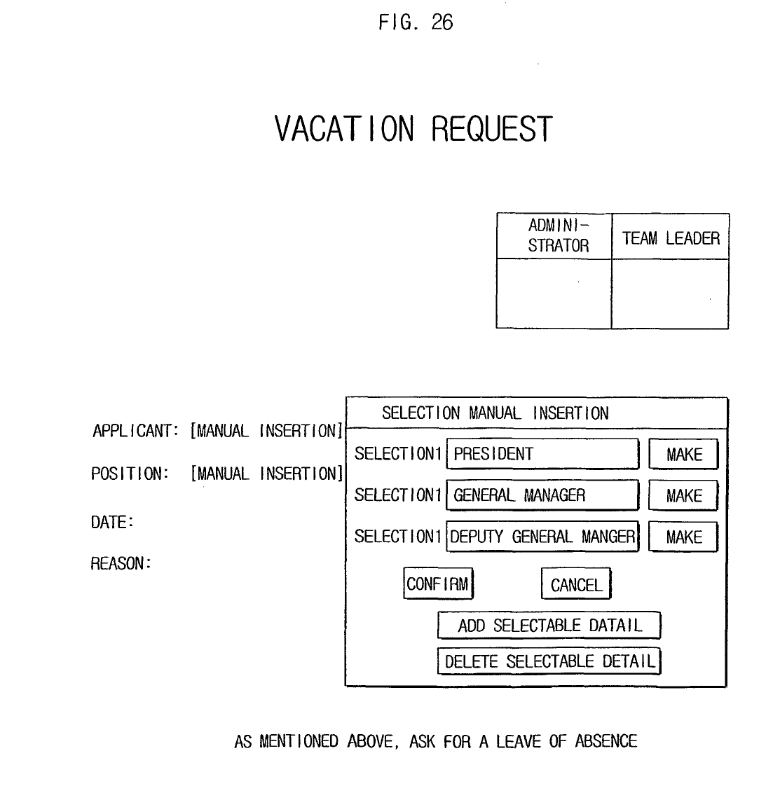

FIG. 26 is another sample of the selection manual inserting dialogue box described by referring to FIG. 25.

That is, the selection manual inserting dialogue box described by referring to FIG. 25 is that the selectable details, can be selected by form-user, are settled by form-creator in advance in order to be inputted the information of common term.

For example, when two staffs having the same position are fill in the vacation request, one of the two staffs may input ‘employee’ in the ‘POSITION’ item but the other may input ‘staff’ in the “POSITION” item. In that case, by using the method described by referring to FIG. 25, the information of common term can be inputted in each item.

But, another sample of selection manual inserting dialogue box shown in FIG. 26 further comprises a function for inserting a table or a paragraph linked with a pre-selectable word in the vacation request.

In case that information or form is different in accordance with the position title and a table or a paragraph corresponding to the “POSITION” item is previously designated, the method for creating a vacation request will be described by referring to selection manual inserting dialogue box shown in FIG. 26.

If the form-users use selection manual inserting dialogue box shown in FIG. 26, the vacation request can be used independently for each form-user, although the vacation request is formed in shape of one electronic file.

In comparison between one selection manual inserting dialogue box shown in FIG. 25 and another selection manual inserting dialogue box shown in FIG. 26, the selection manual inserting dialogue box shown in FIG. 26 further comprise ‘make’ button corresponding each selectable detail input field.

If the form-creator presses the ‘make’ button with the input part such a mouse, another dialogue box (e.g., it can be applied to the same method performed in the conventional word processor in case of being selected ‘foot note’ function, ‘equation editor’ function and the like) is displayed on the screen of the form-creator terminal 110, and then the form-creator can input a paragraph or a table corresponding to the selectable detail input field.

And, the paragraph or the table can not only be stored along with the original form (i.e., the vacation request) in one electronic file, but also individually in separate electronic file (i.e., total 3 electronic files). It goes without saying that the paragraph and the table can be stored totally in one electronic file or individually in separate electronic file.

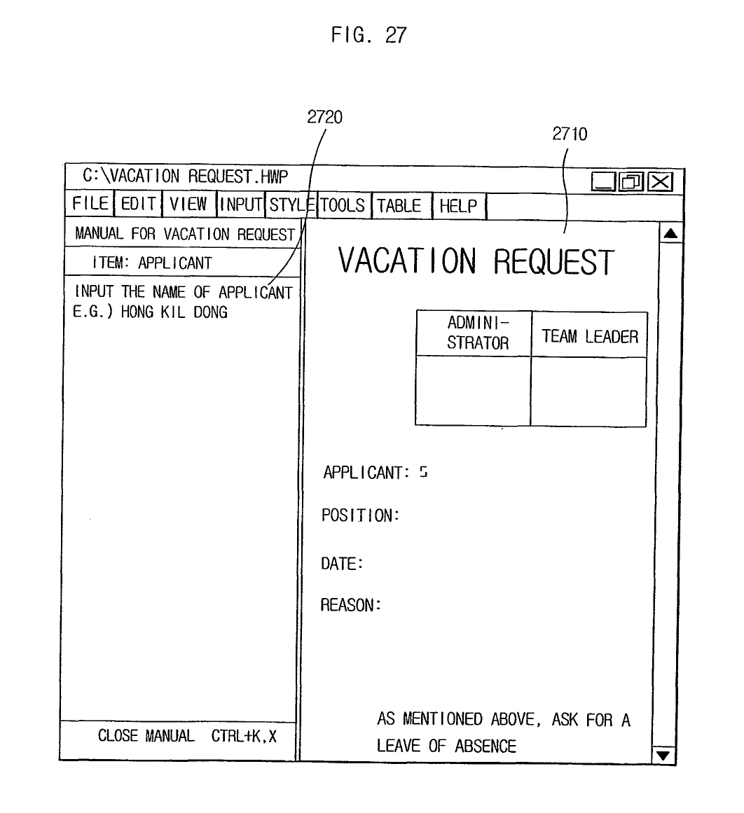

FIGS. 27, 28 and 29 illustrate various form-application windows in accordance with the preferred embodiments of the present invention.

That is, FIGS. 27, 28 and 29 show a method for completing by inputting relevant information in working form created by method described by referring to FIG. 13 through FIG. 26.

Hereinafter, the method to be provided the manual information inserted by the form-creator to the form-user will be described by referring to FIGS. 27, 28 and 29.

As shown in FIG. 27, the form-application window comprising a vacation request opened by the form-user's command comprises a form-display section 2710 and a manual-display section 2720.

If the working form comprises manual function, when the form-user inputs ‘file open’ command, the form-application window can be automatically divided into two sections. That is, if the working form does not comprise manual function, the form-application window can comprise only one section (i.e., the form-display section 2710 only).

Also, even if the working form comprises manual function, the form-application window comprises only one section except in the case that the form-user inputs ‘screen separation’ command. The form-user can input the ‘screen separation’ command by using a dialogue box displayed on the screen of the form-user's terminal 110. That is, if the dialogue box comprises a notice (e.g., ‘Do you want screen separation in order to display manual information’), a ‘confirm’ button and a ‘cancel’ button, when the form-user presses only the ‘confirm’ button with the input part such as a mouse, the form-application window can be divided into two sections.

It goes without saying that the form-application window can be converted two sections (i.e., both the form-display section 2710 and the manual-display section 2720) to one section (i.e., either the form-display section 2710 or a manual-display section 2720) when the form-user inputs predetermined shortcut keys (e.g., ‘CTRL+K, X) or icon.

Also, in the manual-display section 2720, all manual information included in the vacation request can be displayed together or only one of manual information corresponding to the cursor position can be displayed.

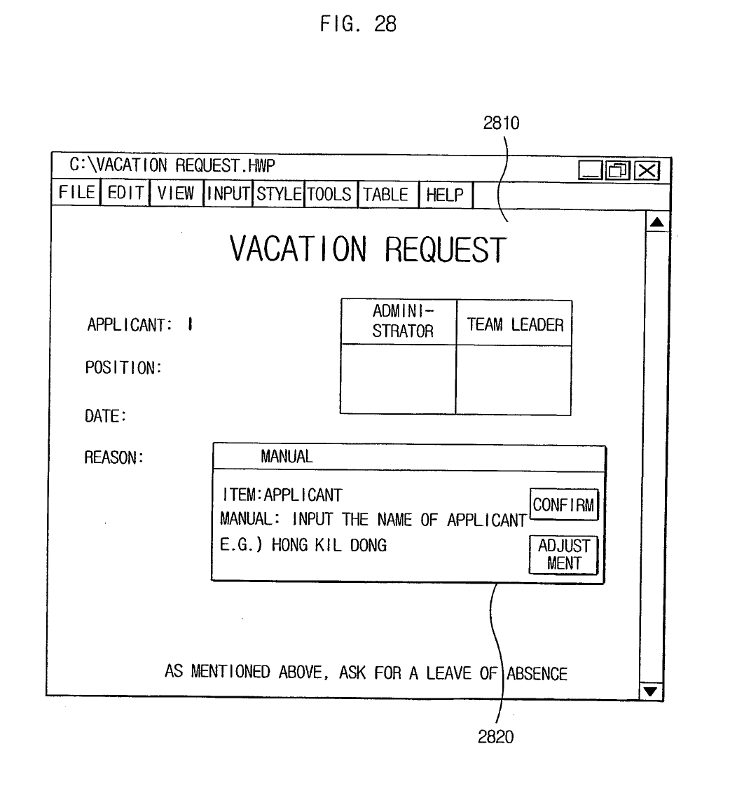

With reference to FIG. 28, a vacation request 2810 and a manual-display dialogue box 2820 are displayed on the screen of the form-user's terminal 110.

When the cursor position is located in the predesignated position (e.g., at the position of inserting the manual information by the form-creator or in selected block by the form-creator), The manual-display dialogue box 2820 can be displayed on the screen of the form-user's terminal 110. The position of the manual-display dialogue box 2820 can be shifted by form-user as the dialogue box for performing spell checking and the like.

In case that the user uses arrow keys in the keyboard in place of the mouse in order to input relevant information in a detail, the manual-display dialogue box 2820 can be hampered by a variety of restrictions. For example, the manual-display dialogue box 2820 can be displayed, only if the cursor position is located in the pre-designated position more than specified time (e.g., more than one second) in order to prevent pointless display of the manual information.

The form-user can fill in the working form by using the manual-display dialogue box 2820, moreover revise the manual information to be convenient of look in person. It goes without saying that the manual information can be allowed password protection in order to prevent pointless revision.

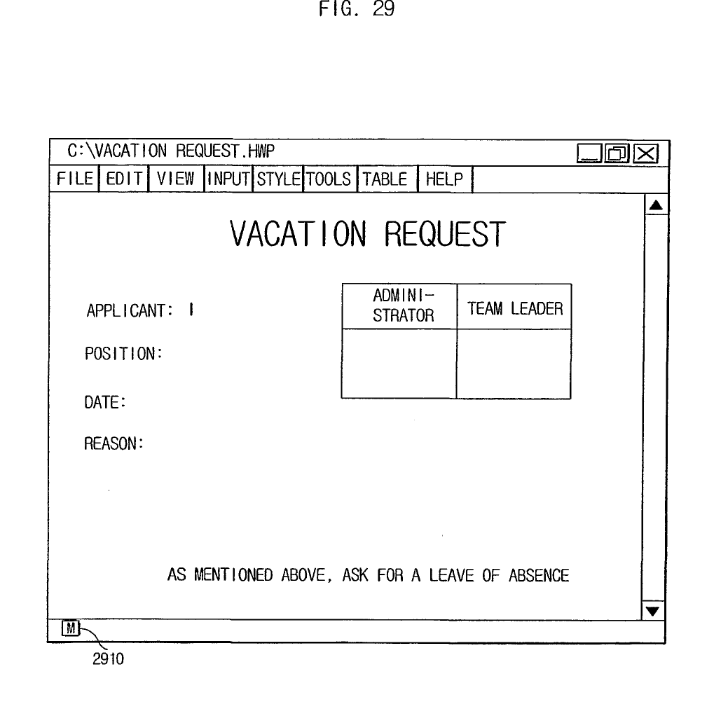

With reference to FIG. 29, the vacation request opened by form-user's ‘file open’ command is displayed on the screen of the form-user's terminal 110. And if the working form comprises manual function, an alarm message 2910 is flickered on the lower portion of the form-application window comprising the vacation request.

In this case, when the form-user presses the alarm message 2910 with the input part such a mouse, the form-application window can be divided into two sections as shown in FIG. 27 or the manual-display dialogue box can be displayed on the screen as shown in FIG. 28.

Also, besides the description by referring to FIGS. 27, 28 and 29, the each color in order to distinguish details having manual information and details having not manual information can be applied differently.

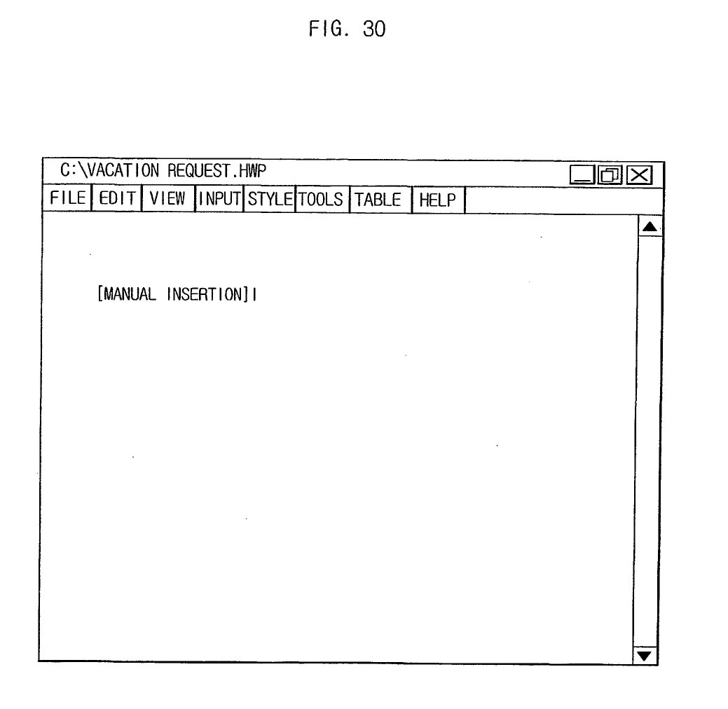

FIGS. 30, 31 and 32 illustrate a form-creating window by user's selecting a manual in the predetermined at least one manuals in accordance with still another preferred embodiments of the present invention.

The method for setting to be linked a manual information to an original form and the method for inserting a table or a paragraph in the working form in a working form by form-user's selection were described already by referring to FIG. 21 through FIG. 26.

Hereinafter, the method for inserting a table, a figure or a paragraph automatically by using manual information and setting to be linked the inserted table, figure or paragraph itself to the manual information will be described by referring to FIGS. 30, 31 and 32.

To meet the convenience of description, the manual information comprises registration form, surface right creation form and lease cancellation form. And the manual information is linked to an original form.

FIG. 30 illustrates a form-application window of the case that the form-user inputs ‘file open’ command in order to fill in a registration form, a surface right creation form or lease cancellation form.

To meet the convenience of description, FIGS. 30, 31 and 32 illustrate the case that the form-user generates necessary working form in empty document (i.e., an original working form) by using a table, a figure or a paragraph in the manual information. Besides, a table, a figure or a paragraph can be inserted at specified position by form-user's command.

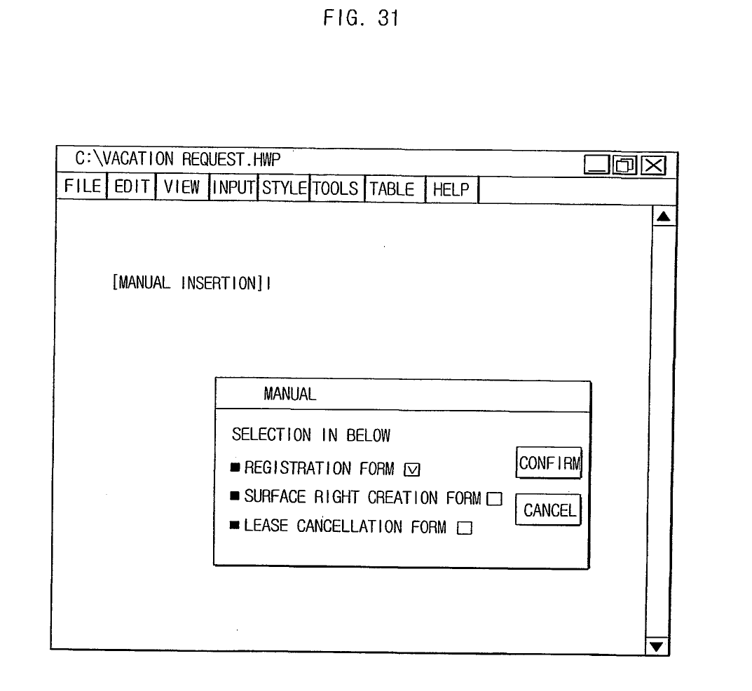

As shown in FIG. 30, because the original working form comprises a composition mark such as ‘[manual insertion]’, when the form-user inputs ‘file open command’ corresponding to the original working form, the selection manual display dialogue box (shown in FIG. 31) is automatically displayed on the screen. Such is similar to the case that the ‘file open’ dialogue box is displayed on the screen first of all when the HANGEUL is executed.

With reference to FIG. 31, the selection manual display dialogue box generated by using the method described by referring to FIGS. 24, 25 and 26 is displayed on the screen, shows a plurality of subsidiary forms in the manual information and requests input the form-user's selection.

The type of the manual information is similar to the aforementioned type of the manual information described by referring to FIG. 22, can comprise a plurality of tables, figures or paragraphs. The each of the tables, figures or paragraphs can be linked to the detail included the selection manual display dialogue box by using ID code and the like.

When the form-user selects one of the subsidiary forms and then presses ‘confirm’ button, the selected subsidiary form is displayed on the screen.

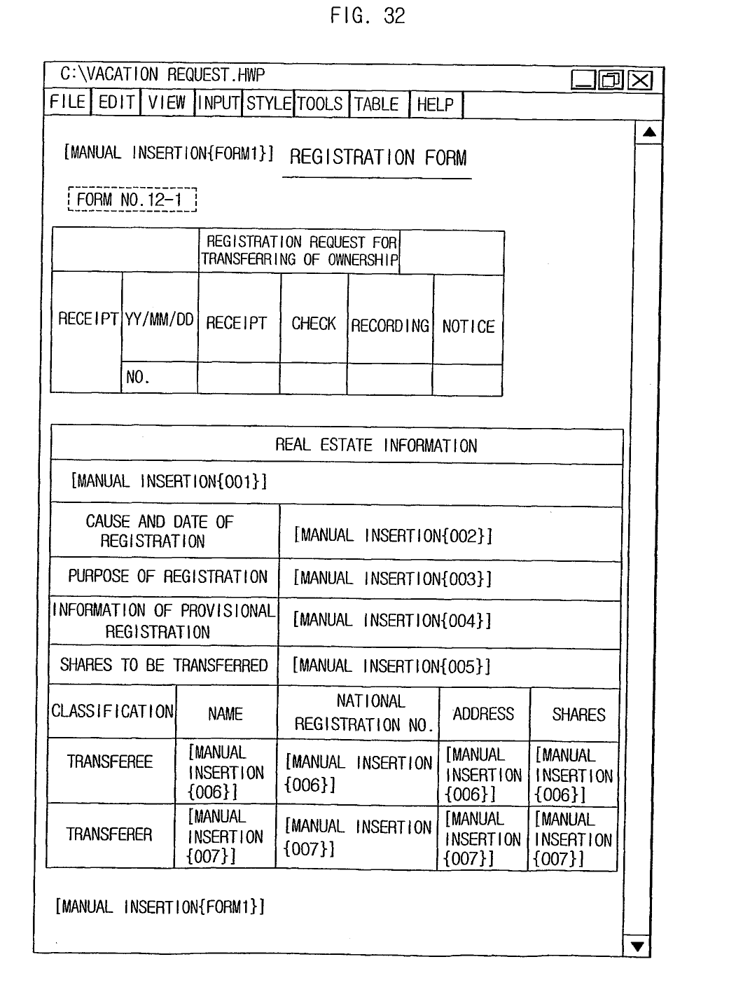

For example, if the form-user selects the registration form of the subsidiary forms and then presses ‘confirm’ button, the registration form (shown in FIG. 32) is displayed on the screen.

That is, the registration form linked to the subsidiary form by form-creator is automatically inserted in the original working form.

The registration form displayed by the aforementioned process comprises manual information corresponding to each cell in the registration form.

Accordingly, when the cursor position is located in a cell of the registration form, the manual information corresponding to the cell is automatically displayed in the predesignated portion of the screen, as shown in FIGS. 27, 28 and 29.

Then, the manual information created by form-creator can comprise subsidiary forms and subsidiary manual information corresponding to the subsidiary forms. The subsidiary forms can comprise tables, paragraph and the like. It goes without saying that the subsidiary forms and the subsidiary manual information can be stored individually in separate electronic file, or stored totally in one electronic file.

The form-user can generate working form including selected table, selected figure or selected paragraph by using the method for inserting a table, a figure or a paragraph in the working form, as described by referring to FIG. 30 through FIG. 32. Also, the form-user can generate working form through a plurality of selection steps during he generates a working form, not through one selection step.

According to the present invention, if the form-user or the form-creator inputs the stored position information (e.g., file address information comprising database number information, directory information, file name information) of the form or the specified information stored in external database, the form or the specified information can be inserted in the working form.

Industrial Applicability

According to the present invention as has been described in detail above, if the kind and the trait of the information to be inputted by a form-user in a form is previously decided and is consisted manual information, when the form-user fills in the form, the manual information can be automatically displayed for the form-user.

According to the present invention as has been described in detail above, if the manual function links to a plurality of databases, when a form-user or a form-creator requests to insert specified information stored in the databases in the working document, the specified information can be automatically inserted in the working document by using the manual function.

Further, the present invention is not limited to the above-described embodiments, and variations and modifications may be made without departing from the scope of the present invention.

1. A method for generating a form comprising manual function by using a form management program, wherein the form management program is installed in a user terminal and executed according to a execution command of a user, said method comprising the steps of:
displaying a working document on a screen of the user terminal;
displaying a manual-inserting area corresponding to the manual-inserting command on the screen, when a manual-inserting command is inputted by the user;
linking a position information to a manual information, when the manual information is inputted in the manual-inserting area, wherein the position information is equivalent to the cursor position in case that the manual-inserting command is inputted in a working document; and
saving the manual information in a storage device.

2. The method according to claim 1, further comprising the step of inserting at least one subsidiary form in the manual-inserting area, wherein the subsidiary form comprises at least one selected from the group consisting of a table, a text and a figure.

3. The method according to claim 2, further comprising the steps of:
displaying the manual-inserting area corresponding to the manual-inserting command on the screen, when the manual-inserting command is inputted at a position in the subsidiary form by user;
linking a position information to a manual information, when the manual information is inputted in the manual-inserting area, wherein the position information is equivalent to the cursor position in case that the manual-inserting command is inputted in the working document; and
saving the manual information in the storage device.

4. The method according to claim 1, wherein said form management program comprises a manual-addition function in the form.

5. The method according to claim 1, wherein said user terminal is at least one selected from the group consisting of a computer, a mobile phone and a personal digital assistant (PDA).

6. The method according to claim 1, wherein said form management program is at least one selected from the group consisting of a word processor, a spreadsheet, a web site creation and management tool, a mapping program, a diagramming program and an image editing program.

7. The method according to claim 1, wherein the position information corresponding to the manual-inserting command is a range information comprising a cursor position of at least one selected from the group consisting of a table, a text and a figure in the working document.

8. A method for using a form comprising manual function by using a form management program, wherein the form management program is installed in a user terminal and executed according to a execution command of a user, said method comprising the steps of:
displaying the form comprising manual function on a screen of the user terminal, when an ‘open’ command for displaying the form comprising manual function is inputted by user;
determining whether a cursor is located in a pre-designated range or not, wherein the pre-designated range is designated for automatically executing a manual function;
retrieving a manual corresponding to the pre-designated range, when the cursor is located in the pre-designated range; and
displaying the manual on the screen.

9. The method according to claim 8, said step of displaying the manual on the screen is at least one selected from the group consisting of a step of splitting the display into two, a step of using a dialog box and a method of using a alarm message so as to display the manual and the form on the screen.

10. The method according to claim 8, further comprising the steps of:
displaying a manual corresponding to the subsidiary form, when the manual comprises at least one subsidiary form, wherein the subsidiary form can be selectively inserted in the form by user;
retrieving the subsidiary form in a storage device, when the selection information of a subsidiary form is inputted by user; and
inserting the subsidiary form in the form.

11. The method according to claim 10, further comprising the steps of:
retrieving a manual corresponding to the pre-designated range, when the subsidiary form comprises a manual and the cursor is located in the pre-designated range for automatically executing a manual function; and
displaying the manual on the screen.

12. A method for generating a form comprising manual function by using a network comprising the steps of:
receiving a document-generating request from a user terminal;
receiving a manual-inserting request at a position in a working document from the user terminal;
sending a manual-inserting area corresponding to the manual-inserting request to the user terminal;
receiving a manual information from the user terminal, wherein the manual information is inputted in the manual-inserting area;
linking a position information to the manual information, when the manual information is inputted in the manual-inserting area, wherein the position information is equivalent to a cursor position in case that the manual-inserting request is inputted in a working document; and
saving the manual information in a storage device.

13. The method according to claim 12, further comprising the step of inserting at least one subsidiary form in the manual-inserting area, wherein the subsidiary form comprises at least one of a table, a text and a figure.

14. The method according to claim 13, further comprising the steps of:
receiving the manual-inserting request at a position in the subsidiary form from user terminal;
sending a manual-inserting area corresponding to the manual-inserting request to user terminal;
receiving a manual information which is inputted in the manual-inserting area;
linking a position information to the manual information, when the manual information is inputted in the manual-inserting area, wherein the position information is equivalent to the cursor position in case that the manual-inserting request is inputted in the working document; and
saving the manual information in the storage device.

15. The method according to claim 12, wherein said network is a wireless communication or a cable communication.

16. The method according to claim 12, wherein said user terminal is at least one selected from the group consisting of a computer, a mobile phone and a personal digital assistant (PDA).

17. A method for using a form comprising manual function by using a network comprising the steps of:
receiving an ‘open’ request for displaying a form from a user terminal;
retrieving a form corresponding to the ‘open’ request in a storage device;
sending the form to the user terminal;
retrieving a manual corresponding to the pre-designated range, when the form comprises manual function and a cursor is located in the pre-designated range for automatically executing a manual function; and
sending the manual to the user terminal.

18. The method according to claim 17, further comprising the steps of:
sending a manual corresponding to a subsidiary form, when the manual comprises at least one subsidiary form, wherein the subsidiary form can be selectively inserted in the form by user;
retrieving the subsidiary form in a storage device, when the selection information of a subsidiary form is received from the user terminal; and
inserting the subsidiary form in the form.

19. The method according to claim 18, further comprising the steps of:
retrieving a manual corresponding to the pre-designated range in the storage device, when the subsidiary form comprises corresponding manual and the cursor is located in the pre-designated range for automatically executing a manual function; and
sending the retrieved manual to user terminal.

20. A system for generating a form comprising manual function by using a network, said system comprising:
means for receiving a document-generating request, a manual-inserting request or a manual information from a user terminal;
means for sending a manual-inserting area corresponding to the manual-inserting request to user terminal;
means for linking a position information to the manual information, when the manual information is inputted in the manual-inserting area, wherein the position information is equivalent to a cursor position in case that the manual-inserting request is inputted in a working document; and
means for saving the manual information.

21. A system for providing a form comprising manual function by using a network, said system comprising:
means for receiving an ‘open’ request for displaying a form from a user terminal;
means for retrieving a form or manual corresponding to the user's ‘open’ request;
means for sensing a cursor position; and
means for sending the form or manual to the user terminal.

22. An apparatus for generating a form comprising manual function, said apparatus comprising:
a storage device; and
a processor coupled to said storage device,
wherein said storage device storing a program for controlling said processor; and
said processor operative with said program to receive a document-generating request from a user terminal;
receive a manual-inserting request at a position in a working document from the user terminal;
send a manual-inserting area corresponding to the manual-inserting request to the user terminal;
receive a manual information from the user terminal, wherein the manual information is inputted in the manual-inserting area;
set a position information to be linked the manual information, when the manual information is inputted in the manual-inserting area, wherein the position information is equivalent to the cursor position in case that the manual-inserting command is inputted in the working document; and
save the manual information in a storage device.

23. The apparatus according to claim 22, said processor further operative with said program to comprise at least one subsidiary form in the manual-inserting area wherein the subsidiary form comprises at least one selected from the group consisting of a table, a text and a figure.

24. The apparatus according to claim 23, said processor further operative with said program to receive the manual-inserting request at a position in the subsidiary form from user terminal;
send a manual-inserting area corresponding to the manual-inserting request to user terminal;
receive a manual information from the user terminal, wherein the manual information is inputted in the manual-inserting area;
set a position information to be linked the manual information, when the manual information is inputted in the manual-inserting area, wherein the position information is equivalent to the cursor position in case that the manual-inserting command is inputted in the working document; and
save the manual information in the storage device.

25. An apparatus for using a form comprising manual function, said apparatus comprising:
a storage device; and
a processor coupled to said storage device,
wherein said storage device storing a program for controlling said processor; and
said processor operative with said program to receive an ‘open’ request for displaying a form from a user terminal;
retrieve a form corresponding to the ‘open’ request in a storage device;
send the form to the user terminal;
retrieve a manual corresponding to the pre-designated range, when the form comprises manual function and a cursor is located in the pre-designated range for automatically executing a manual function; and
send the manual to the user terminal.

26. The apparatus according to claim 25, said processor further operative with said program to send a manual corresponding to a subsidiary form, when the manual comprises at least one subsidiary form, wherein the subsidiary form can be selectively inserted in the form by user;
retrieve the subsidiary form in a storage device, when the selection information of a subsidiary form is received from the user terminal; and
insert the subsidiary form in the form.

27. The apparatus according to claim 26, said processor further operative with said program to retrieve a manual corresponding to the pre-designated range in the storage device, when the subsidiary form comprises corresponding manual and the cursor is located in the pre-designated range for automatically executing a manual function; and
sending the retrieved manual to user terminal.

28. A computer-readable medium having stored thereon computer-executable instructions and realized in concrete by program of instructions, which could be executable by digital processing unit, for generating a form comprising manual function, the method for generating the form comprising the steps of:
displaying a working document on a screen of a user terminal;
displaying a manual-inserting area corresponding to the manual-inserting command on the screen, when a manual-inserting command is inputted from the user;
linking a position information to a manual information, when the manual information is inputted in the manual-inserting area, wherein the position information is equivalent to the cursor position in case that the manual-inserting command is inputted in a working document; and
saving the manual information in a storage device.

29. The computer-readable medium of claim 28, wherein said instructions further perform the step of inserting at least one subsidiary form in the manual-inserting area wherein the subsidiary form comprises at least one selected from the group consisting of a table, a text and a figure.

30. The computer-readable medium of claim 29, wherein said instructions further perform the steps of:
displaying the manual-inserting area corresponding to the manual-inserting command on the screen, when the manual-inserting command is inputted at a position in the subsidiary form by user;
linking a position information to a manual information, when the manual information is inputted in the manual-inserting area, wherein the position information is equivalent to the cursor position in case that the manual-inserting command is inputted in the working document; and
saving the manual information in the storage device.

31. A computer-readable medium having stored thereon computer-executable instructions and realized in concrete by program of instructions, which could be executable by digital processing unit, for using a form comprising manual function, the method for using the form comprising the steps of:
displaying the form comprising manual function on a screen of a user terminal, when an ‘open’ command for displaying the form comprising manual function is inputted by user;
determining whether a cursor is located in a pre-designated range or not, wherein the pre-designated range is designated for automatically executing a manual function;
retrieving a manual corresponding to the pre-designated range, when the cursor is located in the pre-designated range; and
displaying the manual on the screen.

32. The computer-readable medium of claim 31, wherein said instructions further perform the steps of:
displaying a manual corresponding to a subsidiary form, when the manual comprises at least one subsidiary form, wherein the subsidiary form can be selectively inserted in the form by user;
retrieving the subsidiary form in a storage device, when the selection information of a subsidiary form is inputted by user; and
inserting the subsidiary form in the form.

33. The computer-readable medium of claim 32, wherein said instructions further perform the steps of:
retrieving a manual corresponding to the pre-designated range, when the subsidiary form comprises a manual and the cursor is located in the pre-designated range for automatically executing a manual function; and
displaying the manual on the screen.
